(19) United States
(12) Patent Application Publication
(10) Pub. No.: US 2008/0088651 A1
(43) Pub. Date: Apr. 17, 2008

(54) Divided mirror pixels for deformable mirror device

(76) Inventors: Yoshihiro Maeda, Tokyo (JP); Fusao Ishii, Menlo Park, CA (US); Hirotoshi Ichikawa, Tokyo (JP)

Correspondence Address: Bo-In Lin, 13445 Mandoli Drive, Los Altos Hills, CA, 94022, US

(21) Appl. No.: 11/900,540

(22) Filed: Sep. 11, 2007

Related U.S. Application Data
(63) Continuation-in-part of application No. 11/121,543, filed on May 4, 2005, now Pat. No. 7,268,932.
Application No. 11/121,543 is a continuation-in-part of application No. 10/698,620, filed on Nov. 1, 2003.
Application No. 11/121,543 is a continuation-in-part of application No. 10/699,140, filed on Nov. 1, 2003, now Pat. No. 6,862,127.
Application No. 11/121,543 is a continuation-in-part of application No. 10/699,143, filed on Nov. 1, 2003, now Pat. No. 6,903,860.
(60) Provisional application No. 60/844,036, filed on Sep. 12, 2006.

(51) Int. Cl. G09G 5/02; G02B 26/02

(52) U.S. Cl. 345/694; 359/223

(57) ABSTRACT

A mirror device comprising a plurality of mirror elements for modulating illumination light, and each of the mirror elements has a plural number of sub-mirror elements that is a single mirror element divided approximately perpendicularly in an incidence direction of illumination light. A projection apparatus has the mirror device and can project images.

This application is a Non-provisional application of a Provisional Application 60/844,036 filed on Sep. 12, 2006. The Provisional Application 60/844,036 is a Continuation in Part (CIP) application of a pending U.S. patent application Ser. Nos. 11/121,543 filed on May 4, 2005. The application Ser. No. 11/121,543 is a Continuation in part (CIP) application of three previously filed applications. These three applications are Ser. No. 10/698,620 filed on Nov. 1, 2003, Ser. No. 10/699,140 filed on Nov. 1, 2003, and Ser. No. 10/699,143 filed on Nov. 1, 2003 by one of the Applicants of this patent application. The disclosures made in these patent applications are hereby incorporated by reference in this patent application.

### BACKGROUND OF THE INVENTION

1. Field of the Invention

The present invention relates to the field of a spatial light modulator, and specifically to a mirror device that has each mirror element divided into a plurality of sub-mirror elements, and an image display apparatus having the mirror device.

2. Background of the Invention

Even though there are significant advances made in recent years on the technologies of implementing electromechanical micromirror devices as spatial light modulator, there are still limitations and difficulties when employed to provide high quality images display. Specifically, when the display images are digitally controlled, the image qualities are adversely affected due to the fact that the image is not displayed with sufficient number of gray scales.

The electromechanical micromirror devices have drawn considerable interest because of their application as spatial light modulators (SLMs). A spatial light modulator requires an array of a relatively large number of micromirror devices. In general, the number of devices required ranges from 60,000 to several million for each SLM. Referring to FIG. 1A for a digital video system 1 disclosed in a relevant U.S. Pat. No. 5,214,420 that includes a display screen 2. A light source 10 is used to generate light energy for ultimate illumination of display screen 2. Light 9 generated is further concentrated and directed toward lens 12 by mirror 11. Lens 12, 13 and 14 form a beam columnator to operative to columnate light 9 into a column of light 8. A spatial light modulator 15 is controlled by a computer 19 through data transmitted over data cable 18 to selectively redirect a portion of the light from path 7 toward lens 5 to display on screen 2. The SLM 15 has a surface 16 that includes an array of switchable reflective elements, e.g., micromirror devices 32, such as elements 17, 27, 37, and 47 as reflective elements attached to a hinge 30 that shown in FIG. 1B. When element 17 is in one position, a portion of the light from path 7 is redirected along path 6 to lens 5 where it is enlarged or spread along path 4 to impinge the display screen 2 so as to form an illuminated pixel 3. When element 17 is in another position, light is not redirected toward display screen 2 and hence pixel 3 would be dark.

Each of mirror elements constituting a mirror device to function as a spatial light modulator (SLM) and each mirror element comprises a mirror and electrodes. A voltage applied to the electrode(s) generates a coulomb force between the mirror and the electrode(s), thereby making it possible to control and incline the mirror and the mirror is “deflected” according to a common term used in this specification for describing the operational condition of a mirror element.

When a mirror is deflected with a voltage applied to the electrode(s) to control mirror, the deflected mirror also changes the direction of the reflected light in reflecting an incident light. The direction of the reflected light is changed in accordance with the deflection angle of the mirror. The present specification refers to a state of the mirror when a light of which almost the entirety of an incident light is reflected to a projection path designated for image display as an “ON light”, while referring to a light reflected to a direction other than the designated projection path for image display as an “OFF light”.

There is an additional state of the mirror that reflects a light of an incident light in a manner that the ratio of the light reflected to a projection path (i.e., the ON light) and that reflected so as to shift from the projection path (i.e., the OFF light) has a specific ratio. The light reflected to the projection path with a smaller quantity of light than the state of the ON light is referred to as an “intermediate light.”

According to a convention of present specification, it defines an angle of rotation along a clockwise (CW) direction as a positive (+) angle and that of counterclockwise (CCW) direction as negative (−) angle. A deflection angle is defined as zero degree (0°) when the mirror is in the initial state, as a reference of mirror deflection angle.

Most of the conventional image display devices such as the devices disclosed in U.S. Pat. No. 5,214,420 implement a dual-state mirror control that controls the mirrors at a state of either ON or OFF. The quality of an image display is limited due to the limited number of gray scales. Specifically, in a conventional control circuit that applies a PWM (Pulse Width Modulation), the quality of the image is limited by the LSB (Least Significant Bit) or the least pulse width for control related to the ON or OFF state. Since the mirror is controlled to operate in an either ON or OFF state, the conventional image display apparatuses have no way to provide a pulse width to control the mirror that is shorter than the control duration allowable according to the LSB. The least quantity of light, which determines based on the gray scale, is the light reflected during the time duration according to the least pulse width. The limited gray scale leads to a degradation of the image.

Specifically, FIG. 1C shows an exemplary control circuit for controlling a mirror element according to the disclosures made in U.S. Pat. No. 5,285,407. The control circuit includes a memory cell 150. Various transistors are referred to as “M*” where “*” designates a transistor number and each transistor is an insulated gate field effect transistor. Transistors M5 and M7 are p-channel transistors; while transistors M6, M8, and M9 are n-channel transistors. The capacitances C1 and C2 represent the capacitive loads in the memory cell 150. The memory cell 150 includes an access switch transistor M9 and a latch 32a, which is based on a Static Random Access Switch Memory (SRAM) design. The transistor M9 connected to a Row-line receives a DATA signal via a Bit-line. The memory cell 150 written data is accessed when the transistor M9 that has received the ROW signal on a Word-line is turned on. The latch 32a consists of two cross-coupled inverters, i.e., M5/M6 and M7/M8, which permit two stable states, that is, a state 1 is Node A high and Node B low, and a state 2 is Node A low and Node B high.

The mirror is driven by a voltage applied to the landing electrode abutting a landing electrode and is held at a predetermined deflection angle on the landing electrode. An elastic “landing chip” is formed at a portion on the landing electrode, which makes the landing electrode contact with mirror, and assists the operation for deflecting the mirror toward the opposite direction when a deflection of the mirror is switched. The landing chip is designed as having the same potential with the landing electrode, so that a shorting is prevented when the landing electrode is in contact with the mirror.

Each mirror formed on a device substrate has a square or rectangular shape and each side has a length of 4 to 15 μm. In this configuration, a reflected light that is not controlled for purposefully applied for image display is however inadvertently generated by reflections through the gap between adjacent mirrors. The contrast of image display generated by adjacent mirrors is degraded due to the reflections generated not by the mirrors but by the gaps between the mirrors. As a result, a quality of the image display is worsened. In order to overcome such problems, the mirrors are arranged on a semiconductor wafer substrate with a layout to minimize the gaps between the mirrors. One mirror device is generally designed to include an appropriate number of mirror elements wherein each mirror element is manufactured as a deflectable mirror on the substrate for displaying a pixel of an image. The appropriate number of elements for displaying image complies with the display resolution standard according to a VESA Standard defined by Video Electronics Standards Association or television broadcast standards. In the case in which the mirror device has a plurality of mirror elements corresponding to WXGA (resolution: 1280 by 768) defined by VESA, the pitch between the mirrors of the mirror device is 10 μm and the diagonal length of the mirror array is about 0.6 inches.

The control circuit as illustrated in FIG. 1C controls the mirrors to switch between two states and the control circuit drives the mirror to oscillate to either an ON or OFF deflected angle (or position) as shown in FIG. 1A.

The minimum quantity of light controllable to reflect from each mirror element for image display, i.e., the resolution of gray scale of image display for a digitally controlled image display apparatus, is determined by the least length of time that the mirror controllable to hold at the ON position. The length of time that each mirror is controlled to hold at an ON position is in turn controlled by multiple bit words. FIG. 1D shows the “binary time periods” in the case of controlling SLM by four-bit words. As shown in FIG. 1D, the time periods have relative values of 1, 2, 4, and 8 that in turn determine the relative quantity of light of each of the four bits, where the “1” is least significant bit (LSB) and the “8” is the most significant bit. According to the PWM control mechanism, the minimum quantity of light that determines the resolution of the gray scale is a brightness controlled by using the “least significant bit” for holding the mirror at an ON position during a shortest controllable length of time.

In a simple example with n bits word for controlling the gray scale, one frame time is divided into (2ⁿ−1) equal time slices. If one frame time is 16.7 msec., each time slice is 16.7/(2ⁿ−1) msec.

Having set these time lengths for each pixel in each frame of the image, the quantity of light in a pixel which is quantified as 0 time slices is black (no quantity of light). The onetime slice is the quantity of light represented by the LSB, and 15 time slices (in the case of n=4) is the quantity of light represented by the maximum brightness. Based on quantity of light being quantified, the time of mirror holding at the ON position during one frame period is determined by each pixel. Thus, each pixel with a quantified value which is more than 0 time slices is displayed for the screen by the mirror holding at an ON position with the number of time slices corresponding to its quantity of light during one frame period. The viewer's eye integrates brightness of each pixel so that the image is displayed as if the image were generated with analog levels of light.

For controlling deflectable mirror devices, the PWM calls for the data to be formatted into “bit-planes”, where each bit-plane corresponds to a bit weight of the quantity of light. Thus, when the brightness of each pixel is represented by an n-bit value, each frame of data has the n-bit-planes. Then, each bit-plane has a zero or one value for each mirror element. In the PWM described in the preceding paragraphs, each bit-plane is independently loaded and the mirror elements are controlled according to bit-plane values corresponding to them during one frame. For example, the bit-plane representing the LSB of each pixel is displayed as one time slice.

When adjacent image pixels are displayed with a very coarse gray scales caused by great differences of quantity of light, thus, artifacts are shown between these adjacent image pixels. That leads to the degradations of image qualities. The degradations of image qualities are specially pronounced in bright areas of image when there are “bigger gaps” of gray scale, i.e. quantity of light, between adjacent image pixels. The artifacts are caused by a technical limitation that the digitally controlled image does not obtain sufficient number of the gray scale, i.e. the levels of the quantity of light.

The mirrors are controlled either at the ON or OFF position. Then, the quantity of light of a displayed image is determined by the length of time each mirror holds, which is at the ON position. In order to increase the number of the levels of the quantity of light, the switching speed of the ON and OFF positions for the mirror must be increased. Therefore, the digital control signals need be increased into a higher number of bits. However, when the switching speed of the mirror deflection is increased, a stronger hinge for supporting the mirror is necessary to sustain a required number of switches of the ON and OFF positions for the mirror deflection. Furthermore, in order to drive the mirrors provided strengthened hinge toward the ON or OFF positions, applying a higher voltage to the electrode is required. The higher voltage may exceed twenty volts and may even be as high as thirty volts. The mirrors produced by applying the CMOS technologies probably is not appropriate for operating the mirror at such a high range of voltages, and therefore the DMOS mirror devices may be required. In order to achieve a control of higher number of the gray scale, a more complicated production process and larger device areas are required to produce the DMOS mirror. Conventional mirror controls are therefore faced with a technical problem that the good accuracy of gray scales and range of the operable voltage have to be sacrificed for the benefits of a smaller image display apparatus.

There are many patents related to the control of quantity of light. These patents include U.S. Pat. Nos. 5,589,852, 6,232,963, 6,592,227, 6,648,476, and 6,819,064. There are further patents and patent applications related to different sorts of light sources. These patents include U.S. Pat. Nos. 5,442,414, 6,036,318 and Application 20030147052. In addition, The U.S. Pat. No. 6,746,123 has disclosed particular polarized light sources for preventing the loss of light. However, these patents or patent applications do not provide an effective solution to attain a sufficient number of the gray scale in the digitally controlled image display system.

Furthermore, there are many patents related to a spatial light modulation that includes the U.S. Pat. Nos. 2,025,143, 2,682,010, 2,681,423, 4,087,810, 4,292,732, 4,405,209, 4,454,541, 4,592,628, 4,767,192, 4,842,396, 4,907,862, 5,214,420, 5,287,096, 5,506,597, and 5,489,952. However, these inventions do not provide a direct solution for a person skilled in the art to overcome the above-discussed limitations and difficulties.

In view of the above problems, an invention has disclosed a method for controlling the deflection angle of the mirror to express higher gray scales of an image in a US Patent Application 20050190429. In this disclosure, the quantity of light obtained during the oscillation period of the mirror is about 25% to 37% of the quantity of light obtained during the mirror is held on the ON position at all times.

According to such control, it is not particularly necessary to drive the mirror at high speed. In addition, it is possible to provide a higher number of the gray scale using a low elastic constant of the hinge that supports the mirror. Hence, such control makes it possible to reduce the voltage applied to the landing electrode.

An image display apparatus using the mirror device described above is broadly categorized into two types, i.e. a single-plate image display apparatus equipped with only one spatial light modulator and a multi-plate image display apparatus equipped with a plurality of spatial light modulators.

In the single-plate image display apparatus, a color image is displayed by changing in turn the color, i.e. frequency or wavelength of projected light is changed by time. The single-plate projection apparatus does not need an optical structure used for color composition, and is characterized in being inexpensive for having a simple optical structure using a single mirror device. However, when a color sequential method is used with the single-plate image display apparatus images are displayed with colors sequential by time-division technology. Higher levels of gray scales of each color are necessary to display within a time period which is one flame period being divided for every color. The time period expressing the gray scale per color is short that further increases the difficulties of displaying an image with large gray scale. In addition, in the color sequential method, a break-off in each color by switching the color is conceivable, causing a phenomenon referred to as “color breakup” that creates annoyance and discomfort, and observers cannot make high quality image observation.

In a multi-plate the image display apparatus, a color image displayed by allowing the spatial light modulators corresponding to beams of light having different colors, i.e. frequencies or wavelengths of the light, to modulate the beams of light; and combined with the modulated beams of light at all times. In a color method of the multi-plate image display apparatus, the gray scale of a single color can be expressed using the whole flame period, an image with large gray scale can be displayed, and a bright image can be obtained by R, G, and B being projected at the same time. However, each of three, that are illumination light, the ON light and the OFF light, needs to travel different optical paths, causing a problem that in such a color method, optical paths in the optical system is complicated, and the size of the optical structure has to be large. Note that the conventional image display apparatus has a configuration that a mirror device has a deflection axis of the mirror being set to an diagonal line of the quadrate mirror. A diffracted light from a mirror in the mirror device does not enter the projection optical path, and as a result, the incident directions of the illumination lights are orthogonal to each other.

The conventional mirror device consists of a mirror array in which a plurality of quadrate mirror elements are arranged lengthwise and crosswise. Each of the mirror elements in the device corresponds to each pixel to be projected. Each of the mirror elements modulates incident illumination light in accordance with an image signal, and thereby adjusts the gray scale of the projected light. The mirror in each of the mirror elements can change the deflection angle by deflecting around the deflection axis, and is controlled so as to be either of two states, which is the ON state (i.e. a state of reflecting the illumination light to the projection optical path) or the OFF state (i.e. a state of reflecting the illumination light to a site other than the projection optical path). However, because a conventional mirror element can control the mirror so as to be in two states only, the illumination light entering into the mirror can be modulated only by changing the time period of holding the mirror in each of the two states, the ON state or the OFF state.

FIG. 2A shows a mirror array of a plurality of mirror elements 12 arranged lengthwise and crosswise and deflection axes 13 of every mirror. The direction of the illumination light 11 entering into the mirror array is indicated by an arrow.

The illumination light 11 is incident on each of the mirror elements 12 so as to be approximate orthogonal with respect to the deflection axis 13 of the mirror. The range of the incident angle of the illumination light 11 is assumed to be approximately 10° to 17° from the normal line of the mirror surface when the mirror of each mirror element 12 is horizontal with respect to the base surface of the mirror device 10.

FIG. 2B shows an arrangement of the mirror elements 12 where each of the mirror elements 12 is placed alternately in the column line and in the row line in the mirror array of the mirror device 10 shown in FIG. 2A. The shape of each mirror element 12 is an approximate quadrate or a parallelogram. Such a configuration of the mirror array allows the illumination light 11 to be incident from a direction perpendicular to the outer side of the mirror array, that is a direction orthogonal to the deflection axis 13 in FIG. 2B. Accordingly, by configuring such a mirror array and orienting the illumination light to be orthogonal to the deflection axis 13 of the mirror element 12, it is possible to reduce the size of the optical structure of the multi-plate image display apparatus.

However, image data of TV signals, for example, is not the data as shown in FIG. 2B which is accepted by the mirror array. Consequently, the image display apparatus with above mirror device must have a complex computing circuit to convert the image data into the data accepted by the mirror array shown in FIG. 2B. For that reason, a problem is that the device is inferior to the apparatus having the mirror device shown in FIG. 2A in the image quality. The shortcoming, in addition, is that in an image with a number of vertical lines and horizontal lines such as PC data in particular, degradation of resolution is highly visible.

Moreover, in an LCD (Liquid Crystal Device) that is another spatial light modulator, there is a technology of having sub-elements by dividing a single element by using a color filter. When the technology is applied to the mirror device of the present invention, there would be a problem that because the conventional mirror device has a limitation in the optical design. For example, the mirror deflection angel or the incident angel of the illumination light as described above, when an image is divided into rectangular strip pixels as in LCD, contrast is reduced, and consequently a vivid image cannot be displayed.

Patent documents relating to the present application and the abstracts are provided below.

U.S. Pat. No. 6,961,045 discloses a concept of dividing a plurality of light modulation elements on a single spatial light modulator into multiple groups and then illuminating each group with a different primary color. However, a concept relating to the mirror deflection axis is not disclosed.

U.S. Pat. No. 5,231,388 discloses contents such that a single mirror part (mirror array) of DMD is divided so as to correspond to light of each color, and each of the divided mirror parts (mirror array) is independently deflected in accordance with light of each color. However, there is no disclosure of mirror deflection axis in the specification.

U.S. Pat. No. 6,457,833 discloses contents such that a mirror array of DMD is divided into two or more areas so that each of the areas corresponds to each incident light and the mirror deflection axes in every area are oriented in the same direction.

U.S. Pat. No. 5,214,420 discloses a spatial light modulator to which random polarized light is illuminated.

U.S. Pat. No. 6,891,672 discloses contents such that after a light beam is re-modulated by a spatial light modulator incorporating into a rear-projection screen, an image is projected by expanding the modulated beam.

U.S. Pat. No. 6,547,398 discloses contents such that a separated ray of light is projected on a prescribed pixel position by driving a lens array.

U.S. Pat. No. 6,891,968 discloses a method to upscale single pixel wide text associated with flat panel display.

U.S. Pat. No. 7,012,371 discloses a shape of a mirror in order to reduce diffraction light generated when the mirror is irradiated with illumination light.

U.S. Pat. No. 5,920,299 discloses a color display panel having pixels including the first color dot consisting of various sized sub-dot and the second color dot consisting of various sized sub-dot.

U.S. Pat. No. 7,091,986 discloses that one element consists of four RGB dots and the resolution is improved thereby.

U.S. Pat. No. 6,232,936 discloses that a mirror array is divided into sub-arrays, and each of the sub-arrays is controlled as one group.

U.S. Pat. No. 5,510,824 discloses that in a mirror device, mirror elements with different sizes are offset from the standard grid and arranged.

U.S. Pat. No. 5,557,353 and U.S. Pat. No. 5,758,941 disclose light reflective element in which the vertical length and the horizontal length are different.

U.S. Pat. No. 6,523,961 discloses a mirror element on which incident light is not perpendicular to the side of the mirror.

U.S. Pat. No. 5,661,591 discloses a mirror element having a hexagonal mirror.

U.S. Pat. No. 6,469,821 discloses a mirror element having mirrors formed with a jagged leading and trailing edge.

U.S. Pat. No. 6,919,885 discloses a light reflective element for reflecting only light with a prescribed wavelength.

U.S. Pat. No. 6,987,599 discloses that adjacent mirrors perform different pivot actions.

U.S. Pat. No. 3,600,798 discloses that filters with different colors are provided in a light bulb.

U.S. Pat. No. 6,735,008 discloses a device having a cantilever type hinge.

U.S. Pat. No. 5,673,139 discloses a mirror device having a cantilever type hinge.

U.S. Pat. No. 7,011,415 discloses a mirror device having torsion hinge.

U.S. Pat. No. 6,781,731 discloses a mirror device for reflecting illumination light from different directions.

US patent published application 2006/0034006 discloses a hinge consisting of a doped semiconductor.

US patent published application 2005/0190429 discloses a driving method of a mirror with low voltages.

### SUMMARY OF THE INVENTION

In view of the above problems, it is an object of the present invention to provide images of large gray scale by dividing each of the mirror elements in a mirror device into a plural number of sub-mirror elements.

The first aspect of the present invention is to provide a mirror device having a plurality of mirror elements for modulating illumination light and each of the mirror elements comprises a plurality of sub-mirror elements that are a single mirror element divided in approximate parallel to an incidence direction of the illumination light.

The second aspect of the present invention is to provide a mirror device having a plurality of mirror elements for modulating illumination light from a light source and comprising a plurality of hinges extended approximately perpendicularly from a substrate and a sub-mirror element arranged on each of the hinges, and a single mirror element has at least two of the sub-mirror elements.

The third aspect of the present invention is to provide a mirror device comprising a mirror element having a plurality of sub-mirror elements held by a hinge, and the plurality of sub-mirror elements has a deflection axis for deflecting illumination light to a same direction.

The fourth aspect of the present invention is to provide a projection apparatus, comprising a light source for emitting illumination light, a mirror device having a plurality of mirror elements with a plurality of electrodes and a plurality of sub-mirror elements, a control circuit for controlling the mirror device according to an image signal, and a projection optical system for projecting light reflected by each of the sub-mirror elements.

The fifth aspect of the present invention is to provide a projection apparatus, comprising a light source for emitting illumination light, a mirror device having a plurality of mirror elements with a plurality of electrodes and a plurality of sub-mirror elements and having the illumination light being incident approximately perpendicularly, a control circuit for controlling the mirror device according to an image signal, and a projection optical system for approximately perpendicularly projecting the illumination light reflected by the sub-mirror element.

The sixth aspect of the present invention is to provide a mirror device having a plurality of mirror elements for modulating illumination light from a light source, comprising an electrode arranged on a substrate, a plurality of hinges provided in the substrate, a mirror element arranged on the hinge, and a control circuit for controlling the mirror element, and the control circuit of each of the mirror element is connected to at least two word lines or two bit lines.

The seventh aspect of the present invention is to provide a mirror device having a plurality of mirror elements for modulating illumination light from a light source, comprising an electrode arranged on a substrate, a plurality of hinges provided in the substrate, a mirror element arranged on the hinge, and a control circuit for controlling the mirror element, and the control circuit controls the plurality of mirror elements as one group.

These and other objects and advantage of the present invention will no doubt become obvious to those of ordinary skill in the art after having read the following detailed description of the preferred embodiment, which is illustrated in the various drawing figures.

### BRIEF DESCRIPTION OF THE DRAWINGS

The present invention is described in detail below with reference to the following Figures.

FIG. 1A shows a constitution of a conventional image display system with a spatial light modulator (SLM);

FIG. 1B shows a constitution and a control of a spatial light modulator as shown FIG. 1A;

FIG. 1C shows an exemplary control circuit for a mirror element;

FIG. 1D shows the “binary time periods” in the case of controlling SLM by four bit words;

FIG. 2A shows an example of each mirror element constituting the conventional mirror device and a deflection axis of the mirror;

FIG. 2B shows a modification example of the conventional mirror array in FIG. 2A;

FIG. 3 shows an example of sub-mirror elements that a single mirror element constituting the mirror device is divided into two;

FIG. 4A shows an example of constitution of the two sub-mirror elements formed by dividing a single mirror element in the mirror device into two;

FIG. 4B shows a modification example of the constitution of the two sub-mirror elements of FIG. 4A;

FIG. 4C shows an example of further modification in the constitution of the two sub-mirror elements of FIG. 4A;

FIG. 4D shows an example of further modification in the constitution of the two sub-mirror elements of FIG. 4B;

FIG. 5 shows an example of a condition in which the light reflected by each mirror of the two sub-mirror elements in FIG. 4A is incident on the projection lens;

FIG. 6A shows an example of a state in which green illumination light is modulated by a normal mirror device of the two mirror devices in the double plate projection apparatus color method;

FIG. 6B shows an example of a condition in which in a configuration such that adjacent mirror elements of the mirror device having sub-mirror elements of the two mirror devices in the double plate projection apparatus color method, have the deflection angles different by 90 degrees from each other, blue illumination light and red illumination light are modulated simultaneously by each of the sub-mirror elements;

FIG. 6C shows an example of a condition in which in a case that the deflection axes of the mirror elements constituting the mirror device of FIG. 6B have the same orientation, the blue color illumination light and the red color illumination light are modulated simultaneously by the sub-mirror element;

FIG. 7A shows an example that when the sub-mirror 1 and sub-mirror 2 that are a single mirror divided into two are controlled by a PWM control to be the ON state or the OFF state, the sub-mirror 2 is controlled to be in the ON state so as to complement the time period that the sub-mirror 1 is in the OFF state;

FIG. 7B shows an example that an image signal is divided into higher-order bits and lower-order bits, and the light is modulated by assigning the higher-order bits to the sub-mirror 1 and the lower-order bits to the sub-mirror 2;

FIG. 8 shows the entire constitution of the projection apparatus having a mirror device including the sub-mirror elements shown in FIG. 4B;

FIG. 9 shows an example of the sub-mirror elements that are a mirror element constituting a mirror device divided into three;

FIG. 10 shows an example of sub-mirror elements that are a mirror element constituting a mirror device divided into four;

FIG. 11A shows an example that the three sub-mirror elements that are one of the mirror elements constituting the mirror device divided into three correspond one-to-one with the blue illumination light, the green illumination light and the red illumination light, and the illumination light of each color is modulated by each of the sub-mirror elements;

FIG. 11B shows a mirror array in which the deflection axis of the mirror elements shown in FIG. 11A is rotated 90 degrees to the right;

FIG. 11C shows an example of a mirror array in which each of the mirror elements are arranged in a manner such that the deflection axis of each mirror element shown in FIG. 11A is rotated 90 degrees from that of the adjacent mirror element;

FIG. 12A shows an example that the four sub-mirror elements that are one of the mirror elements constituting the mirror device divided into four correspond one-to-one with the blue illumination light, the green illumination light, the red illumination light and the dark green illumination light and the illumination light of each color is modulated by each of the sub-mirror elements;

FIG. 12B shows an example of a mirror array in which the sub-mirror elements are arranged in a manner that of sub-mirror elements shown in FIG. 12A, the deflection axis of the sub-mirror elements is rotated 90 degrees from that of the adjacent sub-mirror element;

FIG. 13A shows an example of sub-mirror elements that are a mirror element constituting a mirror device divided into four; and

FIG. 13B shows an example of independently controlling each of the sub-mirror elements of FIG. 13A as a single mirror element.

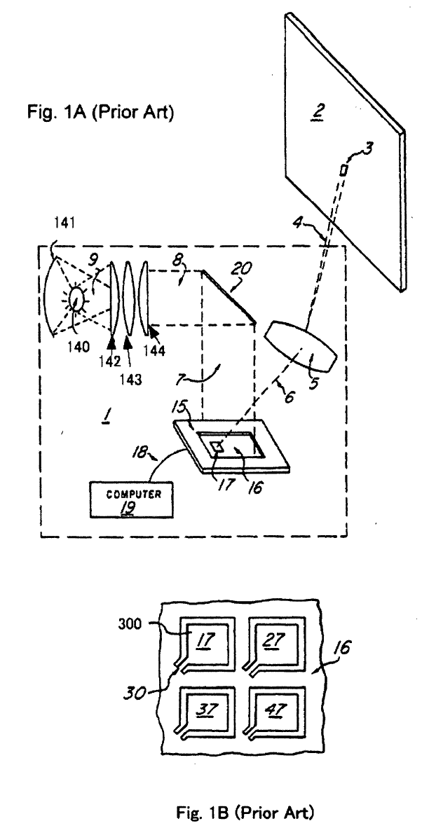

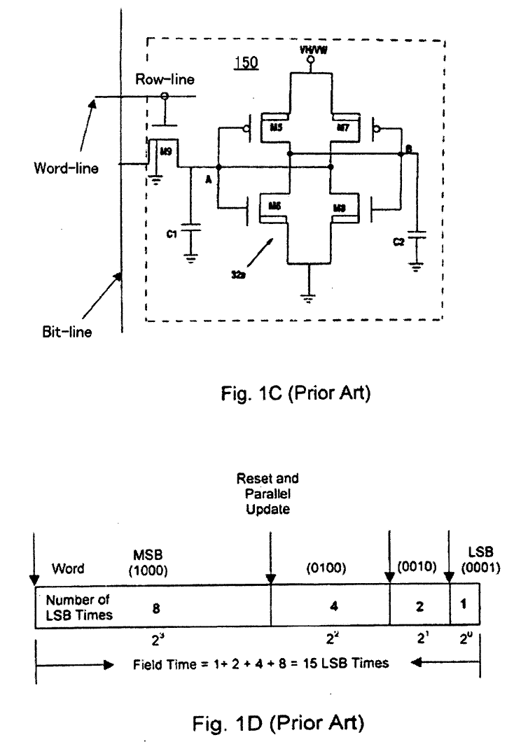

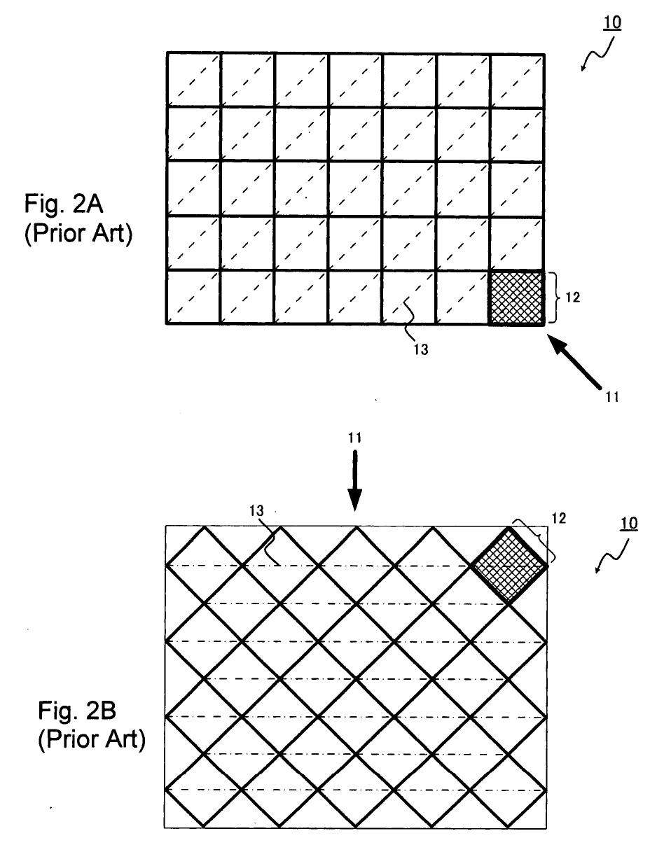

### DESCRIPTION OF THE PREFERRED EMBODIMENT

The following description describes embodiments of a mirror device that includes a plurality of mirror elements and each of the mirror elements is divided into a plurality of sub-mirror elements. The description further includes embodiments of projection apparatus implemented with such a mirror device.

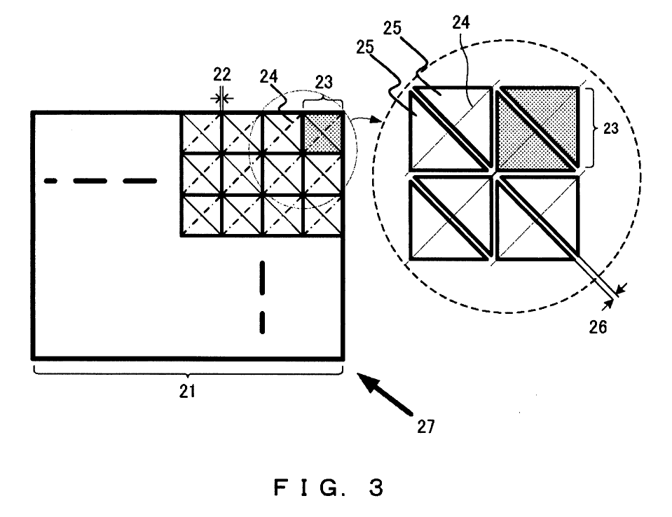

FIG. 3 shows the structural features of two sub-mirror elements. The sub-mirror elements have an approximate triangle shape. A single mirror element includes two sub-mirror elements.

Specifically, FIG. 3 shows a mirror device 21 comprises a plurality of mirror elements 23. Each of the mirror elements 23 is arranged with a mirror deflection axis 24 orthogonal to the light projection direction of an illumination light 27. The mirror device 21 includes a plurality of mirror elements 23. Each of these mirror elements 23 are divided into two approximate-triangle sub-mirror elements 25 along a direction that is orthogonal to the mirror deflection axis 24.

A gap 26 parallel to an optical axis of the illumination light 27 is formed when dividing the sub-mirrors is disposed between the sub-mirrors 25. Diffraction light from the gap is generated and projected along a direction that is orthogonal to each side of the mirror of the sub-mirror elements 25. In the conventional square mirror element, light reflected by the mirror in the ON state is directed to a pupil of a projection lens. When the mirror is controlled to deflect from the ON state to the OFF state, the light is reflected by the mirror in a direction away from the pupil of the projection lens. With each side of the mirror parallel to the mirror deflection axis, there is a problem of degradation of contrast of images. This is caused by the diffraction light generated in a direction orthogonal to each side of the mirror is incident on the pupil of the projection lens. In contras, when the deflection axis in a diagonal direction of the square mirror, the diffraction light from is prevented from entering the pupil of the projection lens. In the present embodiment, the diffraction light is generated in a direction orthogonal to each side of the mirror. The deflection of the sub-mirror elements 25 is controlled in a diagonal direction of the square mirror element thus preventing the diffraction light from entering the pupil of the projection lens. Consequently, the diffraction light generated when the mirror of the sub-mirror elements 25 is deflected in the OFF state is prevented from entering the projection lens. The problem of the contrast degradation is therefore resolved.

An image pixel projected by the mirror device 21 is corresponding one-to-one with one mirror element 23 that includes a pair of the two sub-mirror elements 25. The following descriptions focus on one mirror element 23, the sub-mirrors 25 formed by dividing the mirror element 23, and the gap 26 between the sub-mirrors 25.

The size of each side of one square mirror element 23 in the mirror device is approximately 10-14 μm. A gap 22 between adjacent mirror elements is 0.6-1 μm. In an exemplary embodiment, the mirror element 23 is supported by a perpendicular hinge. The size of a side of the mirror element 23 is in a range of 5-9 μm. By maintaining a same deflection angle of the mirror, the travel distance of the mirror tip is reduced with reduced mirror size. Consequently, the problem of the mirror shifting in a horizontal direction thus physically contact with the adjacent mirror can be reduced. As a result, it is possible to reduce the size of the gap 22 between the adjacent mirror elements 23. Note that the gap 22 between the adjacent mirror elements 23 can be for example 0.13 μm, 0.18 μm, or 0.25 μm. The sized of the gap is determined by the limitation in the manufacturing process.

Recently, a semiconductor component manufacturing process for processing device features around 90 nm or less is now becoming popular and commonly available. Application of the such manufacturing process can flexibly adjust the gap 26 between the sub-mirror elements 25 from the limitation of the current manufacturing process to 0.1-0.3 μm. The sub-mirror elements 25 can be formed with reduced area of 12-40 μm². The gap 22 between the mirror elements 23 and the gap 26 between the sub-mirror elements 25 for dividing the mirror device 23 can be processed through the same processes. Preferably, these gaps are within a range of 0.15-0.55 μm, in order to improve light use efficiency by increasing mirror effective area.

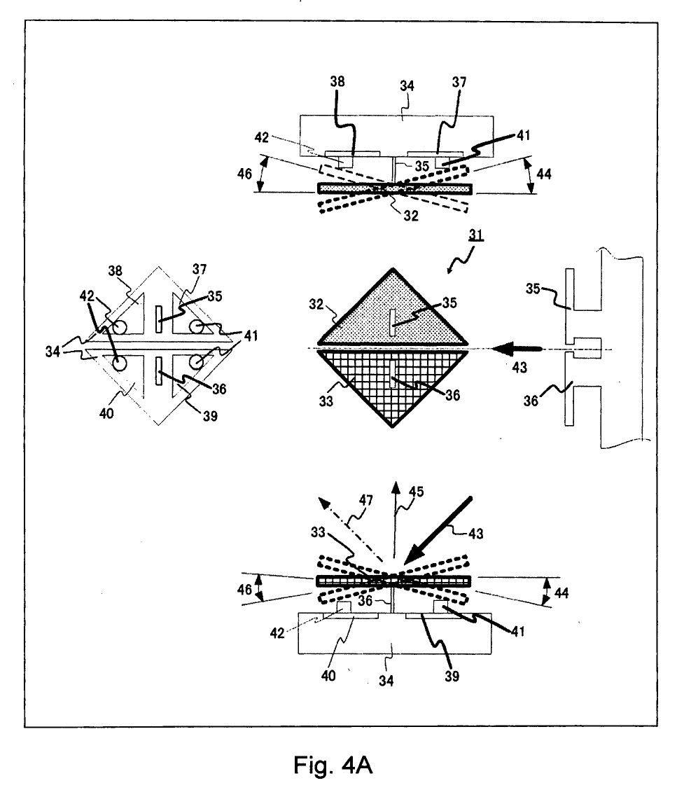

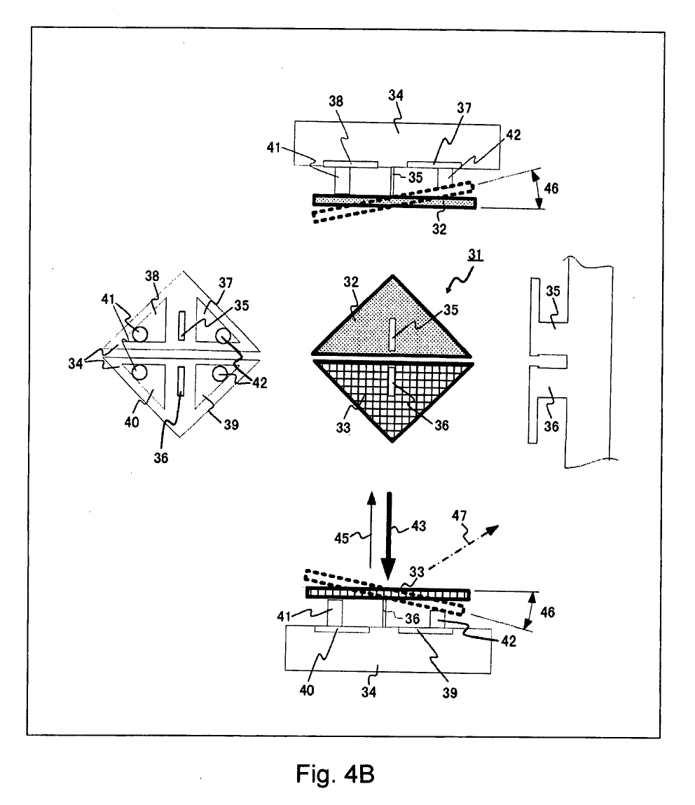

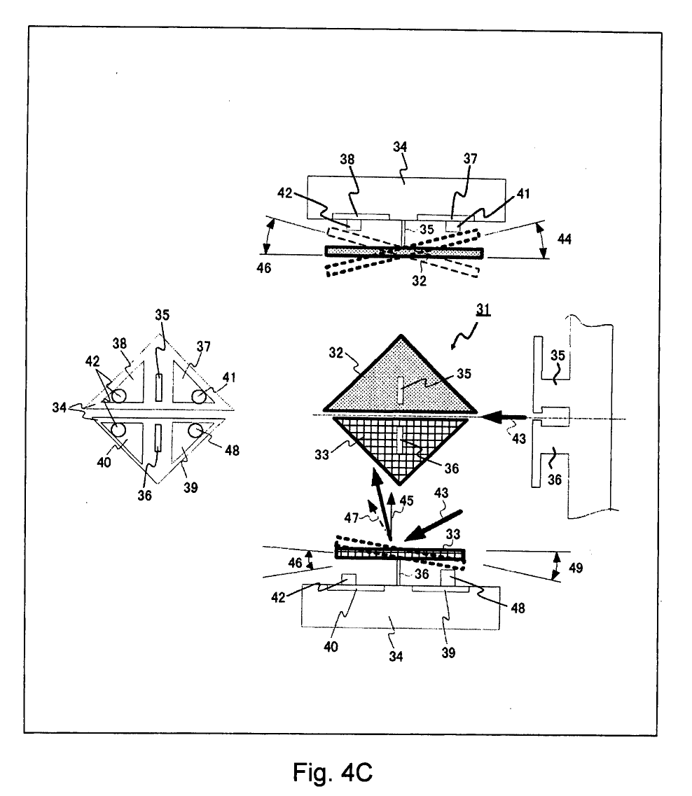

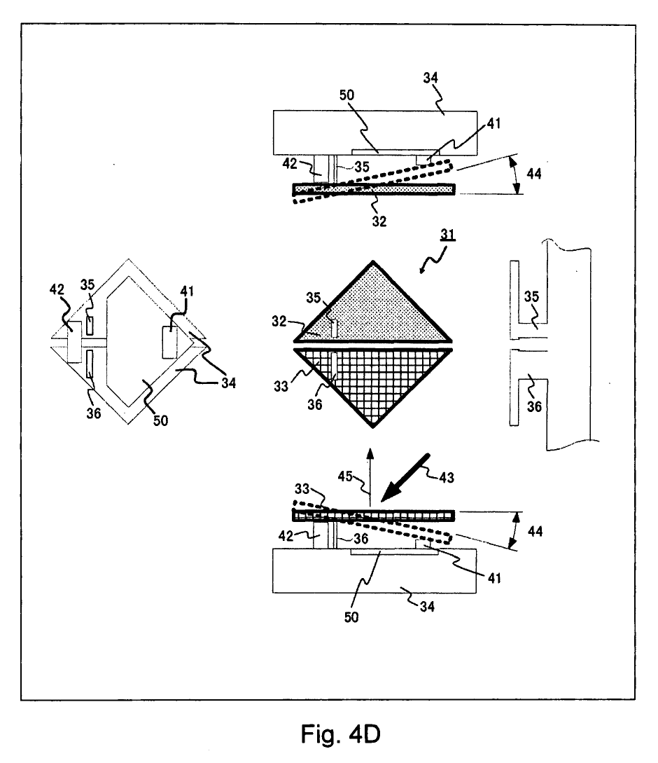

The following descriptions according to FIGS. 4A to 4D are provided for a configuration of the sub-mirror elements formed by dividing one mirror element into two sub-mirror elements.

FIG. 4A includes side cross sectional views, top view and bottom view of a mirror element that includes two sub-mirror elements. According to the configuration of FIG. 3, each mirror element 31 implemented in a mirror device is divided into two approximate-triangle sub-mirror elements. These two sub-mirror elements of the mirror element 31 are referred to as a first sub-mirror 32 and a second sub-mirror 33. Both of the sub-mirrors 32 and 33 are set along a horizontal direction at an initial state. In FIG. 4A, a state when the sub-mirrors 32 and 33 are controlled to tilt to the left, each of the sub-mirrors 32 and 33 is in contact with an OFF stopper 42. The mirror element is operated at an OFF state. A reflected light is designated as an OFF light 47 by reflecting the illumination light 43 away from the projection optical path. On the other hand, a state when the sub-mirrors 32 and 33 are controlled to lean to the right, each of the sub-mirror 32 and 33 is in contact with an ON stopper 41. The mirror element is operated at an ON state. A reflected light is designated as an ON light 45 by reflecting the illumination light 43 to the projection optical path. In an exemplary embodiment, the height of the OFF stopper 42 is appropriately adjusted so that the sub-mirrors 32 and 33 are maintained at an angle to deflect and reflect a light along OFF angle 46 to obtain the OFF light. The height of the ON stopper 41 is also appropriately adjusted to maintain the sub-mirrors 32 and 33 at an angle deflect and reflect a light along an ON angle 44 to obtain the ON light.

The first sub-mirror 32 and the second sub-mirror 33 of FIG. 4A area supported respectively by elastic hinge units 35 and 36. The hinge units 35 and 36 are substantially perpendicular to a substrate 34. The electrodes 37, 38, 39, and 40 are provided on the substrate 34 below each of the sub-mirrors 32 and 33. In FIG. 4A, each of the sub-mirrors 32 and 33 has two electrodes 37 and 38 or 39 and 40. These electrodes are formed across the deflection axis of each of the sub-mirrors 32 and 33. The first sub-mirror 32 supported by the elastic hinge unit 35 on the substrate 34 has two electrodes 37 and 38 at both sides below. The second sub-mirror 33 supported by the elastic hinge unit 36 on the substrate 34 has two electrodes 39 and 40 at both sides below. Each of the electrodes 37, 38, 39, and 40 is electrically connected to a control circuit (not shown in the drawing) to control each of the sub-mirrors 32 and 33 independently by changing the voltage according to a control signal received by the control circuit. The control circuit can be for example a DRAM circuit that includes a condenser and a transistor connected to electrodes.

The transistor is connected to a bit line for transmitting a data signal generated from an image signal and a word line for selecting a line of the mirror array. Here, the bit line and the word line is linked to each of the sub-mirrors 32 or 33 and independently controls each of the sub-mirrors 32 and 33.

These electrodes 37, 38, 39, and 40 have an insulating layer such as a lay of SiO₂, TiN, Al₂O₃, Si, or SiC (not shown) on top the electrodes 37, 38, 39 and 40 are not in physical contact with each of the sub-mirrors 32 and 33. In addition, a layer for preventing stiction such as a layer of FDTS (perfluorodecyltrichlorosilane; C₁₀H₄F₁₇SiCl₃), OTS (octadecyltrichlorosilane; C₁₈H₃₇SiCl₃), PFDA (perfluorodecanoic acid), FODMCS (CF₃(CF₂)₅(CH₂)₂Si(CH₃)₂Cl), or FDDMCS(CF₃(CF₂)₇(CH₂)Si(CH₃)₂Cl) can be formed on top of the insulating layer. The substrate 34 may be a Si substrate.

Each of the sub-mirror 32 and 33 is made of aluminum and supported by the elastic hinge unit 35 or 36. Normally, the mirror surface is maintained in an initial state (in FIG. 4A, the mirror surface is at the horizontal position with respect to the substrate 34). The initial state of the mirror surface can be maintained by setting the voltage applied to the electrodes 37, 38, 39, and 40 located blow the sub-mirrors 32 and 33. The sub-mirrors 32 and 33 and the electrodes 37, 38, 39, and 40 have the same electric potential.

The whole or a part (e.g. the base part, the neck part, or the middle part) of the elastic hinge units 35 and 36 may compose of ceramic, Si or aluminum that has elastic body with restoring force. The elastic hinge units 35 and 36 can also be a torsion hinge arranged with a horizontal configuration. However, if the sub-mirrors 32 and 33 have reduced sizes, a perpendicular elastic hinge unit would require less space and contribute the reduction in size rather than the torsion hinge. The perpendicular elastic hinge units 35 and 36, in addition, can share a common base or pedestal.

FIG. 4A shows the elastic hinge units 35 and 36 have the same shape, made of the same material and use a wide leaf spring in a direction of the deflection axis for supporting the first sub-mirror 32 and the second sub-mirror 33. The two elastic hinge units 35 and 36 are produced in the same process by removing a part between the elastic hinge units 35 and 36 through an etching process. The elastic hinge units 35 and the elastic hinge unit 36 supporting the sub-mirrors 32 and 33 are arranged to face the center of the diagonal side and to reduce the distance from the diagonal side of the mirror element 31 divided into the sub-mirrors 32 and 33. These elastic hinge units 35 and 36 is particularly thin when compared with the size and the weight of the sub-mirrors 32 and 33. The thickness of the elastic hinge units 35 and 36 is from 100 A to 800 A. In an exemplary embodiment, the elastic hinge units 35 and 36 are twisted due to the deflection of the sub-mirrors 32 and 33. Specifically, the sub-mirrors 32 and 33 rotate in a direction parallel to the mirror surface. The distance between the elastic hinge units 35 and 36 is smaller than the diagonal side of the mirror element 31 divided into the sub-mirrors 32 and 33. The travel distance of the tops of the sub-mirrors 32 and 33 in a direction parallel to the mirror surface is therefore shorter. The sub-mirrors 32 and 33 are not in contact with each other. In other words, when the sub-mirrors 32 and 33 deflect, the sub-mirrors 32 and 33 are not in physical contact with each other. Consequently, the gap between the sub-mirrors 32 and 33 may have smaller width.

FIG. 4A shows an initial state with the sub-mirror 32 and 33 controlled in a horizontal position when the voltage applied to the electrodes 37, 38, 39 and 40 is set to zero, the sub-mirrors 32 and 33 and the electrodes 37, 38, 39, and 40 have the same electric potential. When the first sub-mirror 32 and the second sub-mirror 33 are controlled to lean to the left at the OFF angle 46, for example 12° to 14°, the sub-mirrors are maintained at an angle supported by the OFF stoppers 42. The mirror is operated at an OFF state. On the other hand, when the first sub-mirror 32 and the second sub-mirror 33 are controlled to lean to the right at the ON angle 44 for example 12° to 14° and are supported by the ON stoppers 41, the mirror is operated at an ON state.

By setting the voltage to zero when the voltage is applied to the electrodes 38 and 40 in the left side and the sub-mirrors 32 and 33 are in the OFF state, the sub-mirrors 32 and 33 can be restored to the position in the initial state. The mirror is settled to the initial state after a transition period of oscillating state with the mirror oscillated by the restoring force of the elastic hinge units 35 and 36.

On the contrary, by applying of the voltage to the electrodes 37 and 39 in the right side, it is possible to maintain the ON state. In the present embodiment, by applying voltage of 3V or above to the respective right side electrodes 37 and 39 of the sub-mirrors 32 and 33, each of the sub-mirrors 32 and 33 can be deflected to obtain the ON state. Depending on the strength of the restoring force of the elastic hinge units 35 and 36, it is possible to apply the voltage of approximately 5V to 20V to each of the electrodes 37, 38, 39, and 40, to deflect each of the sub-mirrors 32 and 33.

FIG. 4B shows an alternate embodiment with a slightly different configuration form the two sub-mirror elements shown in FIG. 4A.

In FIG. 4B, the OFF stoppers 42 on the electrodes 38 and 40 located below the left side of the sub-mirrors 32 and 33 of FIG. 4A is now implemented as the ON stoppers 41. The height of the ON stopper 41 is appropriately set so that when the voltage is applied to the electrodes 38 and 40, the sub-mirrors 32 and 33 slightly lean to the left with the sub-mirrors 32 and 33 come into contact with the ON stoppers 41 and are approximately horizontal with respect to the substrate 34. When the sub-mirrors 32 and 33 are in contact with the ON stoppers 41, the state is the ON state. The ON state is the initial state when the sub-mirrors 32 and 33 are approximately horizontal with respect to the substrate 34.

On the other hand, the ON stoppers 41 on the electrodes 37 and 39 located below the right side of the sub-mirrors 32 and 33 of FIG. 4A is implemented as the OFF stoppers 42. The height of the OFF stopper 42 is appropriately set so that when the voltage is applied to the electrodes 37 and 39, the sub-mirrors 32 and 33 lean to the right at the deflection angle of equal to or greater than 14°, e.g., 20°. The sub-mirrors 32 and 33 is controlled to contact with the OFF stoppers 42 for reflecting a light along an OFF direction. The incident illumination light 43 is approximately orthogonal to each of the sub-mirrors 32 and 33, which is horizontal with respect to the substrate 34. The configuration other than the modification described above is the same as that of FIG. 4A. As each of the sub-mirrors 32 and 33 leans to the right, the incident illumination light 43 is reflected along the OFF direction shown as the light 47. On the other hand, when each of the sub-mirrors 32 and 33 is horizontal with respect to the mirror array surface or the substrate 34, the incident illumination light 43 is reflected along the ON direction shown as the light 45.

In FIG. 4B, when the incident illumination light 43 is approximately orthogonal to the mirror surface, the ON light 45 is reflected perpendicular to the mirror along the same axis as the optical axis of the illumination light. Therefore, the illumination light 43 does not have to enter from an oblique direction as described in FIG. 4A. Instead, the illumination light can be projected from a direction perpendicular to the deflection axis to obtain the ON light. The size of the optical system can be further reduced.

Two of the electrodes 37, 38, 39, and 40 are provided to each side of the sub-mirrors 32 and 33. The first sub-mirror 32 and the second sub-mirror 33 are independently controlled. However, according to FIG. 4B, the OFF state can be maintained by applying the voltage only to the electrodes 37 and 39. The ON state can be also maintained without a requirement to apply voltage to the electrodes 38 and 40 in the ON side. When the sub-mirrors 32 and 33 can be restored to the horizontal state by taking advantage of the restoring force of the elastic hinge units 35 and 36, the ON state can be maintained without a requirement of applying voltage to the electrodes 38 and 40 in the ON side.

As an alternate embodiment, contrary to that of FIG. 4B, it is possible to define a state in which each of the sub-mirrors 32 and 33 is approximately horizontal as the OFF state, and a state in which each of the sub-mirrors 32 and 33 lean as the ON state. However, in such a case, the illumination light 43 is orthogonal to the horizontal sub-mirrors 32 and 33. A projection lens is arranged at off-center position by displacing from the position orthogonal to the horizontal sub-mirrors 32 and 33. Alternatively, instead of projecting the illumination light 43 along a direction orthogonal to the horizontal sub-mirrors 32 and 33, the illumination light 43 is may also projected from the right oblique direction as in FIG. 4A.

FIG. 4C shows another modified embodiment of the configuration of the sub-mirror element shown in FIG. 4A. FIG. 4C has a stopper on the right electrode 39 below the sub-mirror 33 that functions as a middle stopper 48. When a voltage is applied to the electrode 39 below the middle stopper 48, the sub-mirror 33 leans to the right and is supported by the middle stopper 48. The illumination light 43 now functions as an intermediate light between the ON light and the OFF light. The light is oscillating across the pupil of the projection lens with lower light quantity than that of the ON light.

It should be noted that the configuration is the same as that of FIG. 4A except for the configuration such that the height of the middle stopper 48 is appropriately set. The sub-mirror makes an intermediate light deflection angle 49 to project the intermediate light when the voltage is applied to the electrode 39. Sub-mirrors 32 and 33 now have different deflection angles by providing different heights of the ON stopper 41 and the middle stopper 48. The height of the ON stopper 41 below the sub-mirror 32 is set for the sub-mirror 32 to rest at the deflection angle to reflect the light along the direction as the ON light. The height of the middle stopper 48 below the sub-mirror 33 is set for the sub-mirror 33 to rest at the deflection angle to reflect the intermediate light between the deflection angle of the ON light and the deflection angle of the OFF light. The OFF stoppers 42 below the sub-mirrors 32 and 33 are set to the same height. As another embodiment, the heights of the OFF stoppers 42 below the sub-mirrors 32 and 33 can also be set to have different heights for each of the sub-mirrors 32 and 33.

The voltage can be independently applied to the electrodes 37 and 39 to deflect each of the sub-mirrors 32 and 33 in the ON state or the intermediate state. Likewise, the voltage can be independently applied to the electrodes 38 and 40 to deflect each of the sub-mirrors 32 and 33 in the OFF state as well. Accordingly, it is possible to control the deflection of each of the sub-mirrors 32 and 33 independently.

The amount of light between the ON state and the OFF state is adjustable depending on the setting of the height of the middle stopper 48. Therefore, by adjusting the height of the middle stopper 48, the deflection angle 49 for emitting the intermediate amount of light equivalent to the ON state of the sub-mirror 32 divided by an integer. Accordingly, fine control of the gray scale for each color of the illumination light 43 is possible for a color sequential display system that divides one frame period for each color and displays. For each color, the intermediate quantity of light is controllable by using the sub-mirror of the present embodiment. Consequently, higher gray-scaled color image is achievable.

FIG. 4C shows an additional embodiment where the area of the sub-mirror 32 and that of the sub-mirror 33 are different. The amount of the reflected light is adjustable by implementing a configuration with different areas of sub-mirrors. Furthermore, different deflection angles of the sub-mirrors 32 and 33 for the ON state and the intermediate state can be configured by arranging different heights of the ON stopper 41 and that of the middle stopper 48. With Such arrangements by either providing different areas of sub-mirrors 32 and 33 and/or by deflecting the sub-mirrors 32 and 33 to have different deflection angles different amount of reflected light is then adjustable for transmitting to the projection optical system from the sub-mirrors 32 and 33.

In the above exemplary embodiments, equal distance are configured between each of the electrodes 37, 38, 39 and 40 and the sub-mirror 32 or 33. It is understood that different distances between the sub-mirrors 32 and 33 and different control voltage may be applied by varying the distance depending on the sub-mirror.

As an alternate embodiment, it is possible to change the timing of deflection and the deflection state of each of the sub-mirrors 32 and 33. For example, the elastic strength of the elastic hinge units 35 and 35 is changed by changing the width of the elastic hinge or the thickness of the elastic hinge of the elastic hinge units 35 and 36. Consequently, there are flexibility to adjust the control voltage for controlling the deflection of each of the sub-mirrors 32 and 33.

Each of the first sub-mirror 32 and the second sub-mirror 33 may have an electrode disposed in the OFF side on the substrate 34 in order to have large Coulomb force providing the electrodes with a large area. As a result, it is possible to have the sub-mirror 32 and the sub-mirror 33 controlled to operated in the OFF state at the same time. Furthermore, because the number of the transistors for controlling the deflection of the sub-mirrors 32 and 33 in the substrate 34 can be reduced, the costs of manufacturing can be reduced. Furthermore, a reduced control voltage is achievable by employing an electrode with greater height to reduce the deflection angles of the sub-mirrors and to shorten the distance between the electrodes 39 and 40. Additionally, the deflection angles of the sub-mirrors 32 and 33 can be adjustable by changing the area of the electrode and the shape of the electrode.

FIG. 4D shows another exemplary embodiment by further modifying the configuration of the sub-mirror element shown in FIG. 4B. In FIG. 4D, the positions of the ON stoppers 41 and the OFF stoppers 42 of the sub-mirrors 32 and 33 of FIG. 4B are switched. The elastic hinge unit 35 and the elastic hinge unit 36 are disposed at locations away from the center axis of the sub-mirrors 32 and 33. Electrodes are not provided in the OFF side of the sub-mirrors 32 and 33. An electrode 50 is provided to each of the sub-mirror 32 and the sub-mirror 33 only in the ON sides. The configuration is the same as that of FIG. 4B except for the feature described above. In this configuration, the elastic hinge unit 34 and the elastic hinge unit 36 have different hinge widths, and smaller restoring force of the elastic hinge unit 35 is arranged than that of the elastic hinge unit 36. As a result, the elastic hinge unit 35 can be driven by smaller electrostatic force compared with that of the elastic hinge unit 36. Note that by changing the material of the elastic hinge unit and the thickness of the elastic hinge, the restoring force of the elastic hinge unit can be appropriately adjusted.

For example, in the mirror element 31 of the present embodiment, three voltages of 0V, 3V, and 5V are applied to the ON electrode 50. The sub-mirror 32 is controlled to deflect to the ON state by applying a voltage of 3V. On the other hand, because the elastic hinge unit 36 of the sub-mirror 33 has stronger restoring force than that of the elastic hinge unit 35, the sub-mirror 33 does not deflect with the 3V voltage. Instead, a voltage of five volts is required to deflect the sub-mirror 33 to the ON state. The illumination light is modulated sequentially first by the sub-mirror 32 with application of the 3V control voltage to the electrode 50, and next by the sub-mirror 33 with application of the 5V control voltage to the electrode 50. For projection of the light with 100% white with all colors fully on the sub-mirrors, 32 and 33 are controlled to operate in the ON state at the same time by applying a voltage of 5V.

By setting the control voltage applied to the electrode 50 to 0V, the sub-mirrors 32 and 33 are controlled to move to a horizontal position thus switching the operational state from the ON state to the OFF state. The OFF state is achieved by making use of the restoring fore of the elastic hinge unit 35 and the elastic hinge unit 36.

Although the above embodiment discloses a single electrode 50 for applying hinges 25 and 26 with different restoring forces for supplying two kinds of voltages, 3V and 5V, to the electrode 50, the control of the ON state and the OFF state of the sub-mirrors 32 and 33 can be independently performed by having two electrodes corresponding to each of the sub-mirrors 32 and 33 in the ON side. An alternate embodiment may be configured by adjusting the area of the electrodes and supplying the same amount of voltage to the electrodes below the sub-mirrors 32 and 33. The Coulomb force affecting each of the sub-mirrors 32 and 33 can be adjusted through adjusting of the electrode areas. It is further feasible to provide a configuration with further division of the electrode 50 and the voltage applied in a number of steps. In addition, as another embodiment, independent control can be performed by having the same restoring force in the elastic hinge units 35 and 36, and having two electrodes only in the ON sides.

It is understood that for each of the sub-mirrors 32 and 33 in FIGS. 4A, 4B, 4C and 4D, the expression in above descriptions including the statements of “lean to the left” or “lean to the right”, the positions of the elastic hinge units 35 and 36 shown in the drawing, the shape of the electrode 50, and the height of the stoppers 42 are statements for the convenience of describing these specific embodiments, and such statements do not and should not be interpreted as limiting to the scope of the present invention.

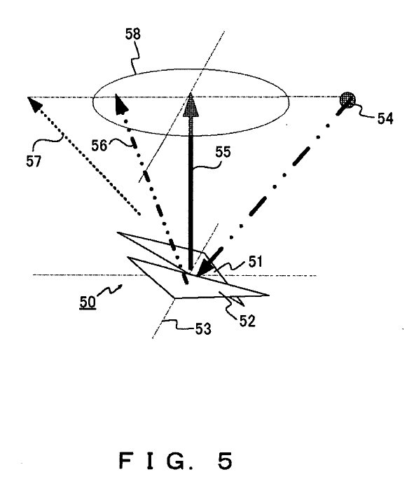

FIG. 5 shows an example of a mirror state in which the light reflected by each mirror of the two sub-mirror elements in FIG. 4A is incident on the projection lens. The illumination light 54 incident on two sub-mirrors 51 and 52 of a single mirror element 50 is separately modulated and reflected from the sub-mirrors 51 and 52. The ¥ sub-mirror 51 is in the ON state at a large deflection angle. The optical axis of the ON light 55 is directed to the center of the pupil of a projection lens 58 that is in a direction approximately perpendicular to the mirror device consisting of the sub-mirrors 51 and 52. At that time, all light flux from the illumination light 54 is reflected to the projection lens 58 and is projected.

On the other hand, the sub-mirror 52 is controlled to operate in the intermediate state at an deflection angle smaller than that of the sub-mirror 51. and the optical path of intermediate light 56 as reflected by the sub-mirror 52 is directed to the periphery of the pupil of the projection lens 58. Approximately half of the light flux of the intermediate light 56 passes the pupil of the projection lens 58. The rest of the light flux of the intermediate light 56, without entering the pupil of the projection lens 58, is absorbed by an optical absorption member (not shown). Accordingly, the intermediate light 56 has an adjustable amount of light directed to the projection 58 for image display. It is feasible to adjust the amount of light by controlling the modulation for controlling the gray scale of display. Adjustment of the amount of light for image display is achievable in addition to the time modulation can therefore be applied to control the gray scale. In addition, by changing the deflection angle of the sub-mirrors 51 and 52, the illumination light can be reflected to a direction along the OFF light 57 and the illumination light is not reflected to enter the projection lens 58.

FIG. 5 shows a control configuration by resting the sub-mirror 52 at a deflection angle between the ON light and the OFF light to control of the intermediate light 56. The control of the intermediate light can be realized by performing the control of oscillation of the sub-mirror 52 to and from the deflection angles of the ON light and the OFF light. For example, when the voltage to the electrode is turned OFF in a state in which the sub-mirror 52 rests on a middle stopper, the sub-mirror 52 moves until making the approximately same angle as the angle before the voltage is OFF in the opposite direction. The oscillation is actuated by the restoring force of the elastic hinge. Consequently, free oscillation state with approximately equal oscillation amplitude is created. In such a case, by adjusting the height of the middle stopper in advance to set the reflected light quantity produced by one cycle of oscillation of the sub-mirror 52 is feasible. The number of times and the time period of free-oscillation of the sub-mirror 52 may also be determined to control the light quantity to be entered to the projection lens 58. A setting of the amount of light quantity to enter into the projection lens 58 within a time period of one cycle of the free oscillation of the sub-mirror 52 may be 25% of the amount of light within the same time period when the sub-mirror is in the ON state. The controllable amount of light enable the image projection to control a gray scale that is four times refined than the gray scale achievable from the control of the ON state and the OFF state. When the area of the sub-mirror 52 is approximately a half, it is possible to obtain a gray scale that has a twice number of gray scales compared to the conventional ON-OFF control schemes.

Following descriptions are related to an exemplary embodiment of a mirror device that includes mirrors with sub-mirror elements mounted on a multiple-plate projection apparatus. A double plate projection apparatus is described that has two mirror devices.

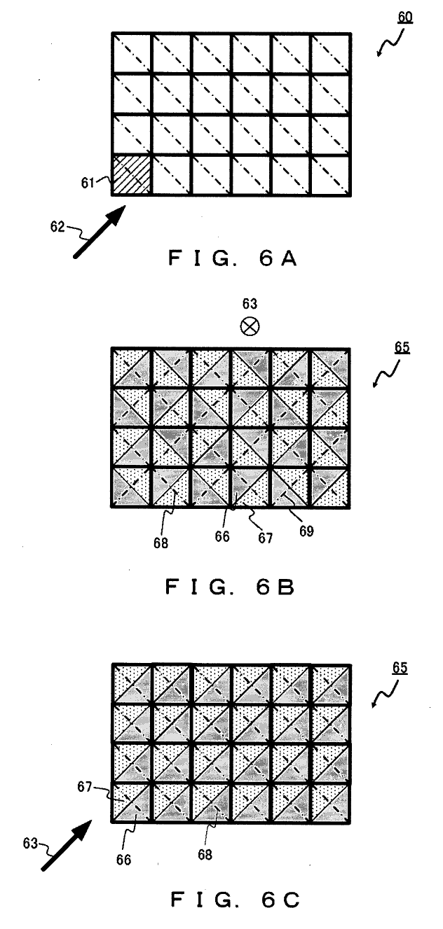

FIG. 6A shows a normal mirror device of the two mirror devices used in the double plate color method, and is an example that shows the green illumination light is modulated. In FIG. 6A, green illumination light 62 is modulated within one frame time period by each of mirror elements 61 included in a single mirror device 60. FIG. 6B shows an example wherein the adjacent mirror elements of the mirror device having sub-mirror elements of the two mirror devices in an image projection system implemented with a double-plate color method. The deflection angles dare projected to two different directions with 90 degrees angular difference from each other. The blue illumination light and red illumination light are modulated simultaneously by each of the sub-mirror elements. Specifically, in FIG. 6B, the red and blue illumination lights 63 correspond one-to-one with each of the sub-mirrors 66 and 67 that are a single mirror element divided into two sub-mirrors in a mirror device 65. The present embodiment describes a sub-mirror 66 reflecting the red illumination light and a sub-mirror 67 reflecting the blue illumination light.

Each of the sub-mirrors 66 and 67 is structured to reflect only the illumination light 63 with the wavelength of red color or blue color. For example, the sub-mirrors 66 and 67 each has a color filter of specific wavelength to modulate and reflecting colors with specific wavelengths of blue and red respectively only. Alternate embodiment is implemented to form a nano-scale structure on the surface of the sub-mirrors 66 and 67. Only the illumination with a single color is selectively reflected to the projection lens. Another embodiment is implemented with a blazed lattice on the surface of the sub-mirrors 66 and 67. Only a single color is reflected in a direction of the projection lens that is a direction of the ON light, and the illumination lights with the rest of the colors are reflected in a different direction along an optical path of an OFF light.

According to the above configurations, simultaneous modulation and reflection of different colors can be performed by the sub-mirrors 66 and 67 that are single mirror element divided into two. By applying the sub-mirrors 66 and 67 for reflecting the R, G, and B illumination light through the projection lens, it is possible to display color images without reducing the resolution.

In FIG. 6B, deflection axes 68 and 69 of the adjacent mirror elements of the sub-mirrors 66 and 67 are arranged so that the orientations of the axes are shifted from one another by 90 degrees. With such configuration, when the illumination light 63 enters from a direction approximately perpendicular to the mirror array surface of the mirror device 65, the ON light is reflected in the perpendicular direction. The reflected light has the same optical axis as the entered light. On the other hand, the OFF light is deflected to two directions which are different by 90 degrees by the sub-mirrors with the deflection axes shifted by 90 degrees from each other and is absorbed by the light absorption member. The OFF light is projected away and does not enter the projection lens.

Accordingly, by arranging the sub-mirrors 66 and 67 for red or blue color illumination light 63 are diagonally facing the sub-mirrors to reflect the same color and the adjacent sub-mirrors 66 and 67 are applied to reflect different colors. It is therefore feasible to obtain vivid images with no color irregularities.

FIG. 6C shows another example of a configuration that the deflection axes of the mirror elements of the mirror device of FIG. 6B have the same orientation. The blue color illumination light and the red color illumination light are modulated simultaneously by the sub-mirror element. In the above exemplary embodiment, when the deflection axes 68 of the mirror elements in the mirror device 65 are oriented in one direction, the sub-mirror 67 of each mirror element reflect the red color illumination light. In the meantime, the sub-mirror 66 reflects the blue color illumination light. For practical applications, the sub-mirrors 66 and 67 of respective colors are regularly set in array.

In the exemplary embodiments shown in FIGS. 6A, 6B, and 6C, the colors of the illumination light 63 are green, red, and blue. However, the colors are not limited to the primary colors, alternate embodiments may be implemented with different kinds of color combinations.

Although FIG. 6A shows the modulation of the green illumination light 62 by the mirror element 61, it is feasible to modulate the green illumination light 62 by dividing the mirror element 61 into sub-mirror elements. In such a case, the green illumination light may be divided into two colors which are normal green and dark green, for example, and the two green lights with different gray scales. These two lights can be modulated by using the sub-mirror elements. As a result, the gray scale of the green light is further enhanced.

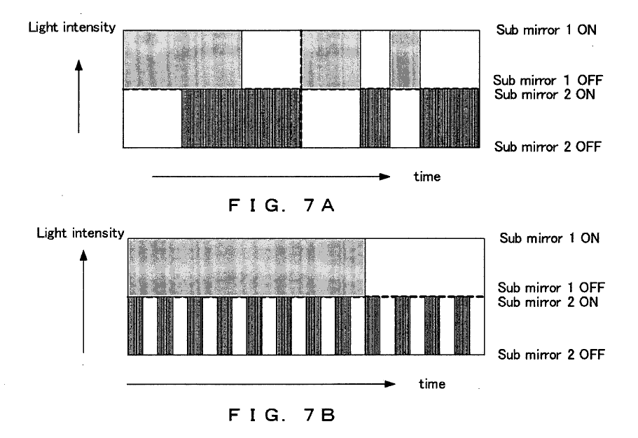

FIG. 7A and FIG. 7B are diagrams for showing a method for controlling the quantity of reflected light by modulation control of the illumination light with the same color by using sub-mirrors.

For example, two sub-mirrors can be controlled to carry out time-division modulation for an illumination light with the same color wherein the illumination of the same color are reflected from both sub-mirrors for independently adjusting the gray scales.

The following description shows an example in which a sub-mirror 1 and sub-mirror reflect the illumination light with the light quantity controlled to an amount of approximately 50%. FIG. 7A shows an example that when the sub-mirror 1 and sub-mirror 2 are single mirrors each divided into two sub-mirrors. The sub-mirrors are controlled by a PWM controller to operated in an ON state or an OFF state. The sub-mirror 2 is controlled to operated in the ON state so as to complement the time period when the sub-mirror 1 is in the OFF state. Both of the sub-mirror 1 and the sub-mirror 2 have a mirror surface area that is a half size of the area of a single mirror, and display images by using the same image signal within one frame time-period. The sub-mirror 1 performs a PWM display control using all binary data of an image signal to projects an amount of light equivalent to a half of the brightness indicated by the image signal. On the other hand, the sub-mirror 2 also performs a PWM display control using all binary data of the same image signal but the sub-mirror 2 is controlled to operate in the ON state only when the sub-mirror 1 is in the OFF state. The sub-mirror 2 performs the display in an order that is different from that of each bit of the binary data of the image signal.

Each of the sub-mirror 1 and the sub-mirror 2 reflects and projects an amount of light equivalent to a half of the brightness indicated by each image signal corresponding to each mirror element. In addition, according to the image signal, the sub-mirror 1 and the sub-mirror 2 can use different data. By dividing data in the image signal, the sequential order of display within one frame time period can be changed. By applying such modulation control, a flicker of the ON state and the OFF state can be made less visible. The quantity of the reflected light can be more evenly controlled so that the pseudo-contour visibility is reduced. It is also possible to match the display timing of the ON light in any time period within the one frame time period. FIG. 7B shows an example that an image signal is divided into higher-order bits and lower-order bits, and the light is modulated by assigning the higher-order bits to the sub-mirror 1 and the lower-order bits to the sub-mirror 2. The sub-mirror 1 is assigned with the higher-order bit data of the binary data in the image signal corresponding to the mirror element. The mirror element modulates the light based on the higher-order bits. The sub-mirror 2 modulates the light with LSB that is the lower-order bits of the binary data in the image signal converted into non-binary data as the smallest unit. By combining the different intensities of reflected light of the sub-mirror 1 that modulates the light based on the higher-order bits and of the sub-mirror 2 that modulated the light base don the lower-order bits, it is feasible to control the image display with larger number of gray scales. Alternate modulation control may be achieved by providing a larger area of the sub-mirror 1 than the area of the sub-mirror 2. Again, the alternate configuration can provide a modulation control to produce display images with higher levels of gray scale.

By controlling the sub-mirror 2 to oscillate between the deflection angle of the ON light and the deflection angle of the OFF light, fine levels of optical gray scale can be generated. An alternate design may be configured by positioning the sub-mirrors to rest at the deflection angle between the deflection angle of the ON light and the deflection angle of the OFF light for projecting an intermediate light. As a result, finer levels of controllable optical gray scale can be achieved. Setting of the deflection angle of the intermediate light is facilitated by setting the deflection angle between the deflection angle of the ON light and the deflection angle of the OFF light approximately within a range between the angles of 14° to 28°.

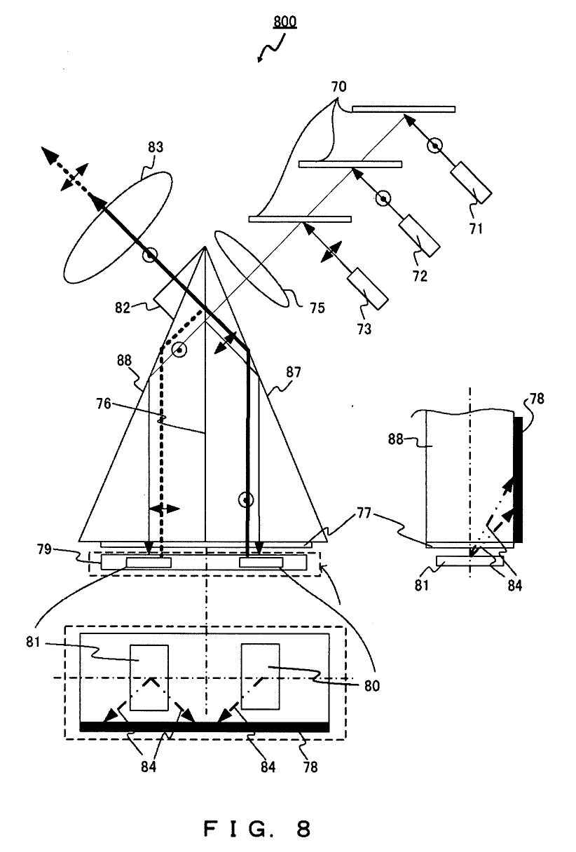

FIG. 8 shows a system configuration of the projection apparatus having a mirror device implemented with the sub-mirror elements shown in FIG. 4B. The optical transmission configuration and light projection principle of a projection apparatus 800 of FIG. 8 is explained below.

The optical transmission in the projection apparatus 800 as shown in FIG. 8 started from the laser sources 71, 72, and 73. Each of these laser sources are light sources for projecting red (R), green (G), and blue (B), light into a dichroic mirrors 70 for reflecting each laser beam through a condenser lens 75 and triangle prisms 87 and 88. The two triangle prisms 87 and 88 are joined together as one prism (PBS prism), and the joint between the prisms 87 and 88 has a PBS film 76 or PBS coating.

A quarter wavelength plate 77 is disposed on an emission surface to receive the illumination light reflected by the PBS prism. The mirror devices 80 and 81 include the two sub-mirror elements shown in FIG. 4B as exemplary embodiment. In addition, an eccentricity correction prism 82, and a projection lens 83 are provided.

First, after being reflected by respective dichroic mirrors 70, each of the illumination lights from the green laser source 73, the red laser source 72 and the blue laser source 71 has a polarization direction different from the green laser source 73 by 90 degrees. The reflected light enters into the triangle prism 87 via an illumination optical system 75. The joint interface of the prisms where two triangle prisms 87 and 88 are joined is provided with a PBS film 76. From the PBS film 76, the p-polarized green illumination light is reflected. The red and blue illumination lights in the s-polarization pass through the PBS film 76. As a result, the illumination lights are separated into the p-polarized green illumination light and s-polarized red and blue illumination lights.

Then, the p-polarized green illumination light and the s-polarized red and blue illumination lights are reflected in the prism 87 and 88, and enter to the quarter wavelength plate 77. The p-polarized green illumination light and the s-polarized red and blue illumination light which passed the quarter wavelength plate 77 is in a circularly-polarized state, and enter the mirror devices 80 and 81 including the sub-mirror elements of FIG. 4B along substantially a perpendicular direction.

The light then modulated and reflected by the mirror devices 80 and 81 that include the sub-mirror elements shown in FIG. 4B has an opposite rotation direction of the circular polarization. When the sub-mirror elements are in the ON state, the reflected light is reflected perpendicularly, and passes through the quarter wavelength plate 77 again. The reflected light, then, is transmitted in a linear polarization state in which the polarization direction is different from the illumination light by 90 degrees.

Then, the green ON light and the red and blue ON lights are reflected by the triangle prisms 87 and 88 once more. The green ON light becomes an s-polarized light (indicated in a thick line one the same optical path as the green illumination light 89) and passes through the PBS film 76. On the other hand, the red and blue ON light become p-polarized (indicated in a broken line on the same optical path as the red and blue illumination light 85). The lights of different colors are reflected by the PBS film 76. When each of the green, red, and blue ON lights enter the projection lens 83 via the eccentricity correction prism 82, color images are projected.

The side plane of the triangle prisms shown as a plane parallel to the paper of FIG. 8, other than the optical path of the illumination and the optical path of the reflected light of the ON light, is a plane orthogonal to the PBS film 76, and is provided with an optical absorption member 78.

Because the mirror device 81 of FIG. 4B corresponding to the red and blue illumination lights has a deflection axes of sub-mirror oriented in two directions, the optical axes of the OFF light are reflected in two directions 84, and the OFF lights of the red and blue illumination lights are absorbed by the optical absorption member 78. Because the mirror device 80 of FIG. 4B corresponding to the green illumination light that has one directional deflection axis, the optical axis of the OFF light is reflected in one direction 84, and the OFF light 84 of the green illumination light is absorbed by the optical absorption member 78. In the present embodiment, by entering the illumination lights of each color to each of the mirror devices 80 and 81 in an approximate perpendicular manner, it is feasible to arrange the mirror devices 80 and 81 symmetrical about the PBS film 76. As another embodiment, the sub-mirrors of the mirror device 81 can be switched so that the red and blue illumination lights are reflected by time-division. In such a case, the reflecting surface of the sub-mirrors is made of aluminum etc., and can reflect illumination light of any color. Therefore, the mirror device 81 can be the same as the mirror device 80.

As another embodiment, it is possible that white light from high-pressure mercury lamp is separated, and to generate red illumination light, green illumination light and blue illumination light which are the same as those of FIG. 8 by using an optical system for orienting the polarization direction in the same direction.

It is desirable that the optical axis of the light emitted from the triangle prisms 87 and 88 is perpendicular to the emission surface. However, the eccentric optical axis are to be corrected by the eccentricity correction prism 82.

In the present embodiment, division into the sub-mirror elements is along a direction orthogonal to the deflection axis of each mirror. Consequently, the diffraction light of the illumination light is prevented from entering into the projection lens 83. Images with improved contrast are projected from the projection lens 83. The divided sub-mirror elements can modulate different colors simultaneously, can display in full colors without reducing the resolution, and can eliminate color breakup. The divided sub-mirror elements can be controlled independently so that the light deflection directions are controlled along different directions.

The sub-mirror elements of FIG. 4D may be implemented in a conventional mirror device. In addition to the ON-OFF states, the illumination light is modulated into ON-OFF and intermediate states. The amount of light projected in an intermediate state is between that of the ON light and the OFF light. As a result, even in a color sequential projection system, it is possible to have a wider range of gray scale without increasing the deflection speed of the mirror, and therefore without increasing the driving voltage.

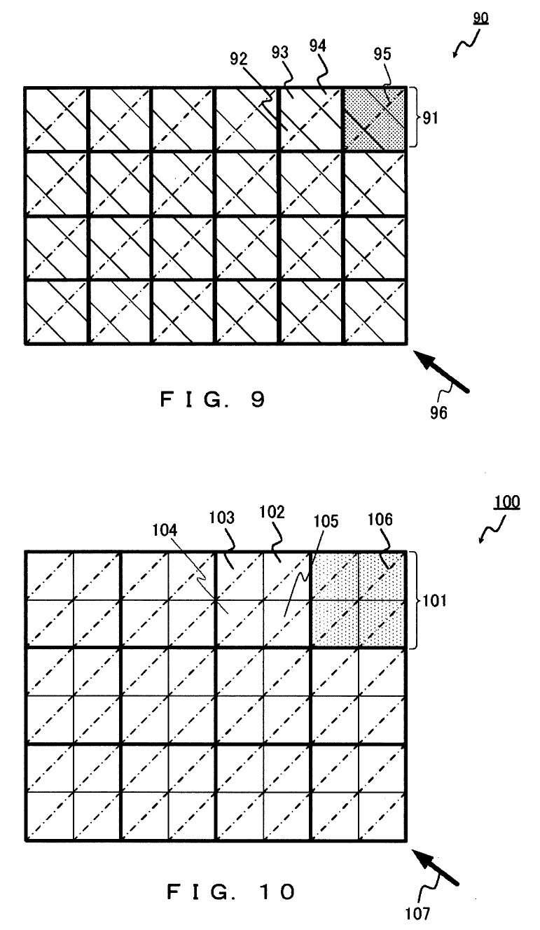

FIG. 9 shows an example of the sub-mirror elements for a mirror element implemented in a mirror device wherein the mirror elements are divided into three sub-mirror elements. Specifically, a mirror element 91 in a mirror device 90 is divided into three sub-mirrors in a direction orthogonal to a deflection axis 95 of the mirror element 91. The three divided sub-mirror elements 92, 93, and 94 are controlled independently by the similar configuration to that in FIGS. 4A to 4D. Consequently, finer control of the amount of reflected light from the mirror element 91 can be achieved to increase the levels of the gray sale.

When illumination light with a single color is modulated by the three sub-mirror elements 92, 93, and 94, the sub-mirror elements 92 and 94 should have the same configuration and receive the same control, and only the sub-mirror element 93 has a different configuration or receives a control different from that of the sub-mirror elements 92 and 94. Consequently, the gray scale and the brightness of in the surrounding area of the sub-mirror elements 92 and 94 can be symmetry about the sub-mirror element 93 that is a center of a single pixel. The symmetry would facilitate observer's recognition of a plurality of sub-mirror elements 92, 93, and 94 as a single mirror element 91. The area of the three sub-mirror elements 92, 93, and 94 can be arranged with an equal size. As another embodiment, the area of the sub-mirror element 93 in the center is the largest of all three sub-mirror elements 92, 93, and 94.

FIG. 10 shows another exemplary embodiment of the sub-mirror elements wherein a mirror element of a mirror device divided is divided into four sub-mirror elements. In the present embodiment, a single mirror element 101 in a mirror device 100 is divided into four sub-mirror elements along directions at 45 degrees in right and left with respect to the deflection axis 106 of the mirror. The four divided sub-mirror elements 102, 103, 014, and 105 are controlled independently by the configuration similar to that of that in FIGS. 4A to 4D. Independent controls of the four sub-mirror elements 102, 103, 104, and 105 enables to generate finer gray scale.

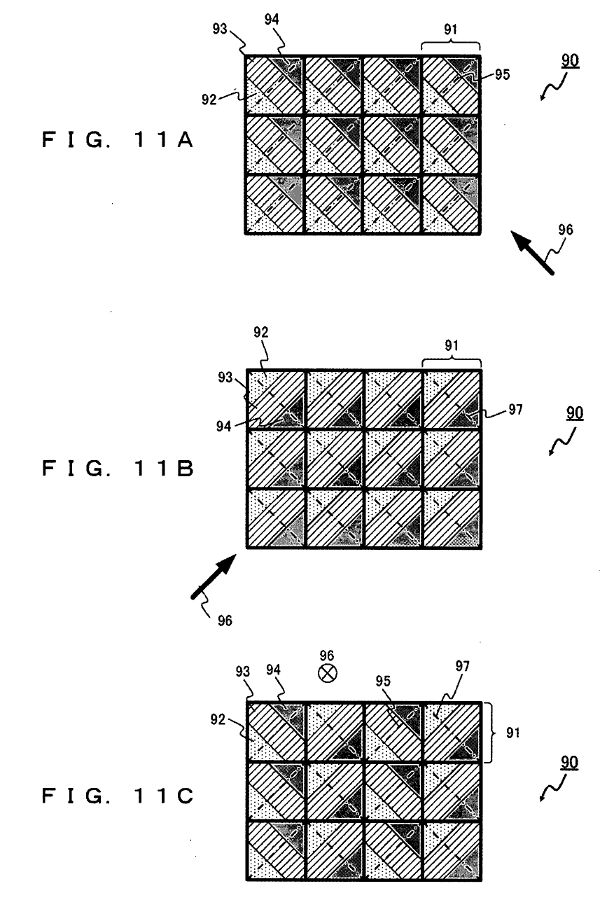

For example, by controlling the sub-mirror elements 102 and 103 as a pair and the sub-mirror elements 104 and 105 as another pair, the control, which is the same as the control in a case of a mirror element divided into two in FIG. 3, can be performed. FIG. 11A, FIG. 11B, and FIG. 11C show an example that the illumination light 96 of each color is incident on each of the three divided sub-mirror elements 92, 93, and 94 in FIG. 9. In FIG. 11A and FIG. 11B, the deflection axis 95 of each of the mirror elements 91 is fixed in the same direction.

Specifically, FIG. 11A shows an example that the three sub-mirror elements 92, 93, and 94 that are one of the mirror elements 91 of the mirror device 90 that is divided into three sub-mirror elements. These three sub-mirror elements correspond one-to-one with the blue illumination light, the green illumination light and the red illumination light, and the illumination light of each color is modulated by each of the sub-mirror elements 92, 93 and 94.

In the mirror device 90 of FIG. 11A, the sub-mirror elements 92, 93, and 94 are formed by dividing one mirror element 91 into three along a direction orthogonal to the deflection axis 95 of the mirror element. With each of the sub-mirror elements 92, 93, and 94 corresponding one-to-one with the blue green and red illumination lights 96, the illumination light of each color is modulated within one frame time period.

FIG. 11B shows a mirror array in which the deflection axis 95 of the mirror elements 91 shown in FIG. 11A is rotated 90 degrees to the right. In this configuration, the deflection axis 96 corresponds to the deflection axis 95 of the mirror elements that is rotated 90 degrees to the right. Color images can be more conveniently generated from a single mirror element 91 is divided into three and the three sub-mirror elements 92, 93, and 94 correspond one-to-one with the blue, green, and red illumination lights 96. The color image can be produced by applying a single plate projection apparatus uses only one mirror device to modulate the illumination light 96 of each color within one frame time period for projecting three colors simultaneously.

Another exemplary embodiment is implemented by a projection system of a multi-plate projection apparatus. The system has a mirror device using two mirror devices 90 having the sub-mirror elements 92, 93, and 94 formed by dividing one mirror element 91 into three as in FIG. 11A and FIG. 11B. It is feasible to display images by combining the reflected light from each of the mirror devices. In such a case, the brightness of the projected light is twice as much as that of the single-plate projection apparatus. Because the color of the sub-mirror element overlaps with each pixel of the image on a screen, vivid image can be obtained.

FIG. 11C shows an example of a mirror array in which each of the mirror elements 91 are arranged in a manner such that the deflection axis 95 of the mirror elements 91 shown in FIG. 11A is rotated 90 degrees from that of the adjacent mirror element 91. Specifically, in FIG. 11C, the mirror elements 91 are arranged so that the deflection axes 95 and 97 of the adjacent mirror elements 91 are configured differently by 90 degrees. In such a case, when the illumination light 96 of each color is incident on the mirror array surface of the mirror device 90 from an approximately perpendicular direction, the ON light of each color is reflected in a perpendicular direction. The reflected light is on the same optical axis as the ON light.

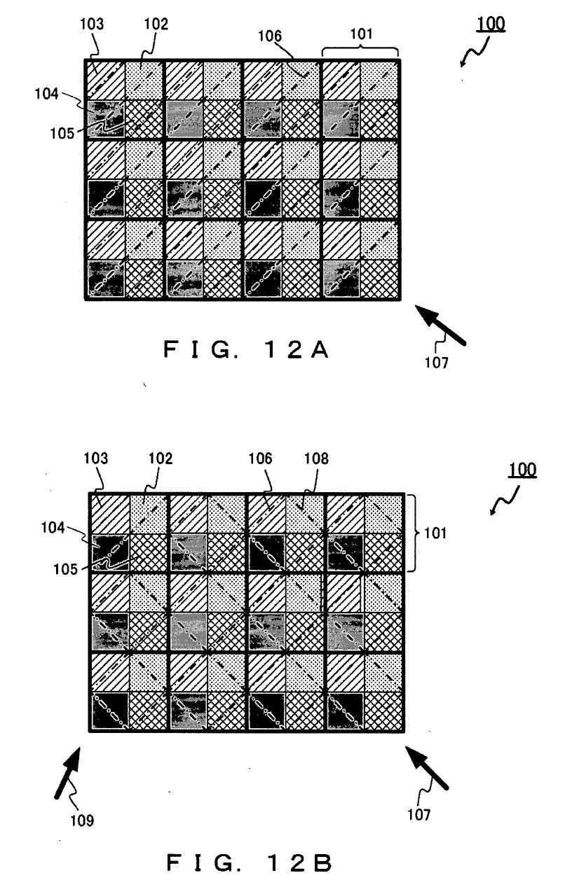

FIG. 12A and FIG. 12B show alternate examples that the illumination light of each color is incident on each of the mirror elements divided into four sub-mirror elements.

Specifically, FIG. 12A shows an example that the four sub-mirror elements 102, 103, 104, and 105 that are divided from one of the mirror elements 101 of the mirror device 100. The four sub-mirror elements correspond one-to-one with the blue illumination light, the green illumination light, the red illumination light and the dark green illumination light and the illumination light 107 of each color is modulated by each of the sub-mirror elements 102, 103, 104, and 105.

In an exemplary embodiment, the sub-mirror elements 102, 103, 104, and 105 that are one mirror element 101 of the mirror device 100 that is divided into four correspond one-to-one with four color illumination light 107 of blue, green, red and dark green. The illumination light 107 of each color is modulated within one frame time period. By having such correspondences of four sub-mirror elements 102, 103, 104 and 105 to the blue, green, red and dark green illumination lights respectively, it is possible to have wider range of green color light expression.

As described above, in addition to the three primary colors of R, G, and B, one of the same primary colors such as B and R can be assigned to the fourth sub-mirror element. By increasing the area of the sub-mirror element corresponding to light of a color with less light quantity, it is possible to obtain bright images while balancing the colors. As another embodiment, it is possible to add a complementary color such as C, M and Y in addition to the three primary colors of R, G and B.

FIG. 12B shows an example of a mirror array in which the sub-mirror elements are arranged in a manner same as that of sub-mirror elements 102, 103, 104, and 105 shown in FIG. 12A while the deflection axis of the sub-mirror elements is rotated 90 degrees from that of the adjacent sub-mirror element. Here, the deflection axis 108 is a deflection axis when the deflection axis 106 of the mirror elements 101 is rotated 90 degrees to the right. Specifically, in FIG. 12B, the deflection axes of the four adjacent sub-mirror elements 102, 103, 104 and 105 of FIG. 12A are rotated 90 degrees so that the four adjacent sub-mirror elements 102, 103, 104 and 105 can be deflected in two directions. As a result, the illumination lights 107 and 109 of different colors can be incident on from the different directions to the sub-mirror elements along the deflection axis directions 106 and 108.

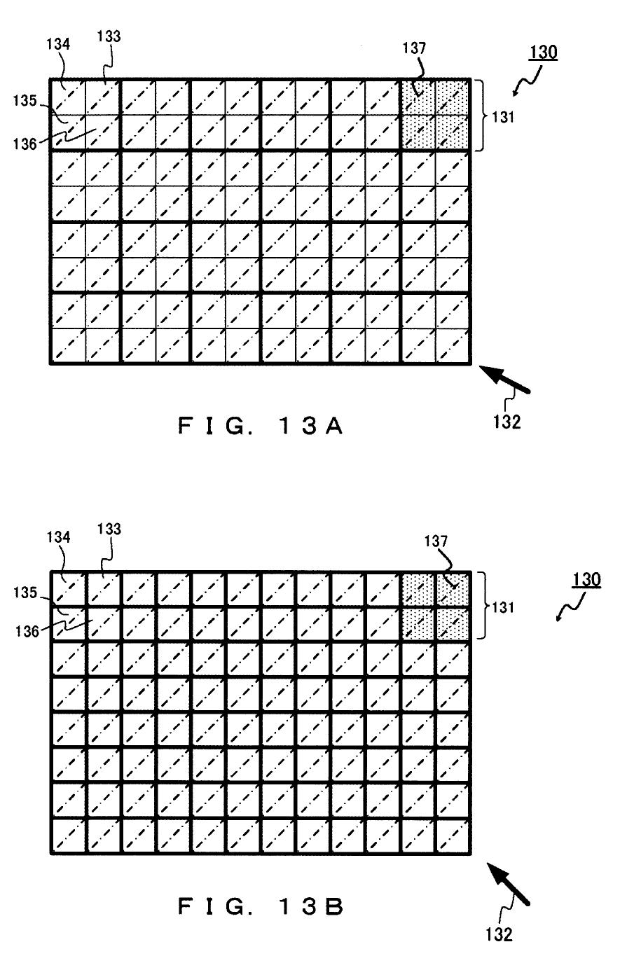

FIG. 13A shows an alternate example of sub-mirror elements that are a mirror element of a mirror device that is divided into four sub-mirror elements.

Mirror elements 131 of a mirror device 130 constituting pixel elements. The number of the pixels corresponds to 800×600 of SVGA (Super Video Graphics Array). The sub-mirror elements 133, 134, 135, and 136 of a single mirror element 131 that is divided into four pixels. The number of the pixels corresponds to 1600×1200 of UXGA (Ultra Extended Graphics Array) that is four times larger than that of SVGA. By implementing four sub-mirror elements 133, 134, 135 and 136 in an SVGA projection system, greater level of gray scales with reduced controllable scale of ⅛, ¼, ½ and 1 are achievable.

FIG. 13B shows an alternate exemplary embodiment of independently controlling each of the sub-mirror elements of FIG. 13A as a single mirror element. Specifically, in FIG. 13B, control for each of the sub-mirror elements 133, 134, 135, and 136 of FIG. 13A are configured as an individual mirror element independently. Image display of UXGA (1600×1200), which have a resolution four times higher than the SVGA, can be obtained.

For a mirror device wherein one side of a mirror of a single mirror element 131 of SVGA is approximately 10μ, the mirrors in each of the sub-mirror elements 133, 134, 135, and 136 are square have approximately 5μ long in each side. Such dimension corresponds approximately with a high-definition screen display such as an UXGA display, is therefore feasible.

In an UXGA display system, the same gray scale can be obtained from each of the sub-mirror elements 133, 134, 135, and 136. Even thought the gray scale of each of the sub-mirror elements 133, 134, 135, and 136 cannot be further improved, it is still possible to obtain high-resolution images. Additionally, according to the contents of the displayed images, gray scale and resolution can be switched for each display area of a screen, and consequently, there is an increased degree of freedom for rearranging and reconfiguring the image display. For example, it is possible to divide the screen area by designating a part of the divided screen is displayed with a high resolution. This is achieved by independently controlling each of the sub-mirror elements 133, 134, 135, and 136 as in UXGA, and the rest of the parts of screen display large gray scale images by synchronous control of each of the sub-mirror elements 133, 134, 135, and 136 as in SVGA.

As another embodiment, the number of mirror elements for synchronous control of the four sub-mirror elements 133, 134, 135, and 136 shown in FIG. 13A is configured to correspond to the number of the HDTV format 1920×1080. The display of images for two screens of HDTV can be arranged using the mirror array by independently controlling each of the sub-mirror elements 133, 134, 135, and 136 as shown in FIG. 13B.

As described above, the mirror device including the sub-mirror elements described as the present embodiment can be applied to both of a single-plate projection apparatus and a multi-plate projection apparatus. By diving each mirror element into sub-mirror elements, and controlling each of the sub-mirror elements independently, images with larger gray scale than those of the conventional single-plate projection apparatus can be displayed. It is no longer necessary to rely on the time-division of one frame time period for modulating lights for image display of multiple colors. With sub-mirror elements as described above, it is possible to have a simpler and less expensive structure than the conventional multi-plate projection apparatuses such as double-plate or triple-plate, and in addition, vivid images can be obtained.

Accordingly, the mirror device with each mirror element divided into a plurality of sub-mirror elements and a projection apparatus having the mirror device are described above. The mirror device includes mirror elements that are divided into sub-mirror elements. It would be obvious that various changes and modifications can be made to these embodiments without departing the scope and the concept of the invention. Accordingly, the present specification and drawings should not be considered as limitation of the invention but should be considered as specific examples.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

What is claimed is:

1. An image projection device receiving a light from an illumination light source through an illumination optic for projecting to a spatial light modulator (SLM) having a plurality of deflectable mirror elements wherein:
each of the mirror elements comprises at least two sub-mirror elements divided by a sub-mirror dividing gap disposed on said mirror element along a direction substantially parallel to an incidence direction of the illumination light.

2. The image projection device of claim 1 wherein:
each of said mirror elements further comprises a hinge extended substantially perpendicularly from a substrate supporting said SLM; and electrodes disposed near said hinge for receiving control signals for independently controlling each of said sub-mirror elements.

3. The image projection device of claim 1 wherein:
said sub-mirror elements having a deflection axis for deflecting the illumination light to a same direction.

4. The image projection device according to claim 1, wherein:
each of the mirror elements having deflection axis configured along at least two different directions.

5. The image projection device according to claim 1, wherein:
each of the mirror element having substantially a square shape and said sub-mirror dividing gap disposed substantially diagonally on said square shape dividing each of said mirror elements into substantially two triangular sub-mirror elements.

6. The image projection device according to claim 3, wherein:
the deflection axis in each of the mirror elements is in a same direction in a vertical row, a horizontal row, or a diagonal row, and is 90 degrees different from the deflection axis of the adjacent mirror element.

7. The image projection device according to claim 1, wherein:
each of said sub-mirror elements is further supported on a separate hinge extended substantially perpendicularly from a substrate supporting said SLM.

8. The image projection device according to claim 1, further comprising:
an electrode for each of the sub-mirror elements allowing each sub-mirror element to be independently controlled.

9. The image projection device according to claim 1, further comprising:
an electrode disposed on a substrate near a group of said sub-mirror elements for simultaneously controlling said group of sub-mirror elements.

10. The image projection device according to claim 1, wherein:
a controller for applying a voltage to an electrode for independently controlling each of the sub-mirror elements.

11. The image projection device according to claim 1, wherein:
at least one of the sub-mirror elements of the mirror element is controllable to operate in an intermediate state or an oscillating state.

12. The image projection device according to claim 1, wherein:
at least one of the sub-mirror elements in the mirror element has a deflection angle different from a deflection of another sub-mirror element.

13. The image projection device according to claim 1, wherein:
at least one of the sub-mirror elements of the mirror element is controllable to operate at an ON state substantially parallel to a substrate surface or a mirror array surface.

14. The image projection device according to claim 1, wherein:
an area of one of the sub-mirror elements is substantially between 12 m² to 40 μm².

15. The image projection device according to claim 1, wherein:
at least one of said mirror elements is divided into three sub-mirror elements wherein an area of a sub-mirror element in the center is larger than or equals to an area of two other sub-mirror elements.

16. The image projection device according to claim 1, wherein:
one of the mirror elements is divided into an even number of sub-mirror elements and every sub-mirror elements have substantially a same shape.

17. The image projection device according to claim 1, wherein:
one of the mirror elements is divided into an odd number of sub-mirror elements.

18. The image projection device according to claim 1, wherein:
at least two of the sub-mirrors have approximately the same area.

19. The image projection device according to claim 1, wherein:
at least two sub-mirror elements having two different areas.

20. The image projection device according to claim 1, wherein:
said sub-mirror dividing gap disposed on the mirror element having a gap width substantially between 0.15 μm to 0.55 μm.

21. The image projection device according to claim 1, wherein:
a gap between adjacent mirror elements on said SLM having a gap width equals to or greater than a gap width of said sub-mirror dividing gap disposed on said mirror elements.

22. The image projection device according to claim 1, wherein:
the number of the mirror elements is the number of pixels corresponding to an HDTV (High Definition TeleVision) format, and the number of the sub-mirror elements is larger than the number of pixels of the HDTV format.

23. The image projection device according to claim 1, wherein:
each of the sub-mirror elements in the mirror element has a reflection surface for reflecting illumination light with different colors.

24. The image projection device according to claim 1, wherein:
each of the sub-mirror elements in the mirror element has a reflection surface for reflecting illumination light with the same color.

25. An image projection device receiving a light from an illumination light source through an illumination optic for projecting to a spatial light modulator (SLM) having a plurality of deflectable mirror elements wherein:
each of the mirror elements comprises at least two sub-mirror elements divided by a sub-mirror dividing gap disposed on said mirror element;
a plurality electrodes disposed on a substrate supporting said SLM for receiving a control signal from a controller to control said sub-mirror elements; and
a projection optical system for projecting light reflected by each of the sub-mirror elements.

26. The image projection apparatus of claim 25 wherein:
said projection optical system projecting substantially perpendicular illumination light reflected by the sub-mirror element.

27. The image projection apparatus according to claim 25, wherein:
the shape of the mirror element is approximately square, and each of the sub-mirror elements in the mirror element has a deflection axis in a direction orthogonal to a diagonal direction of the mirror element.

28. The image projection apparatus according to claim 25, wherein:
the light source is a laser source.

29. The image projection apparatus according to claim 25, wherein:
at least two of the sub-mirror elements of said mirror elements having substantially an equal area.

30. The image projection apparatus according to claim 25, wherein:
the control circuit applies a plurality of voltage to said electrode for generating different coulomb forces between the mirror and the electrode.

31. The image projection apparatus according to claim 25, wherein:
the control circuit applies a plurality of different driving voltages to the electrodes.

32. The image projection apparatus according to claim 25, further comprising:
at least a second SLM and at least a second light source for projection at least two illumination lights to said at least two SLMs.

33. The image projection apparatus according to claim 25, wherein:
at least one sub-mirror element of the mirror element reflects the illumination light with a quantity of intermediate light that is between an ON state and an OFF state toward the projection optical system.

34. The image projection apparatus according to claim 25, wherein:
each of the sub-mirrors of the mirror element is controlled by different data bits of the image signal indicating a pixel.

35. The image projection apparatus according to claim 25, wherein:
a control pattern between the sub-mirror elements of the mirror element is changed according to the image signal.

36. The image projection apparatus according to claim 25, wherein:
the illumination light projected from said light source is polarized light.

37. The image projection apparatus according to claim 25, further comprising:
at least two of the mirror devices are comprised, and the mirror element of at least one of the mirror devices is divided into a plurality of sub-mirror elements.
at least a second SLM and at least a mirror element of said SLMs comprising at least two sub-mirror elements.

38. The image projection apparatus according to claim 25, wherein:
one pixel is displayed by the sub-mirror element according to the image signal.

39. The image projection apparatus according to claim 25, wherein:
each of said sub-mirror elements further reflecting said illumination light for projecting and displaying pixels with different gray scales according to an image signal.

40. The image projection apparatus according to claim 25, wherein:
the shape of the mirror element is approximately square, and each of the sub-mirror elements has a deflection axis in a direction orthogonal to a diagonal direction of the mirror element.

41. The image projection apparatus according to claim 25, wherein:
the sub-mirror element has an ON state in which the illumination light is reflected toward the projection optical system, an OFF state in which the illumination light is not reflected toward the projection optical system, an intermediate state in which a part of the illumination light is reflected toward the projection optical system, and an oscillating state in which reflecting and not reflecting the illumination light toward the projection optical system are alternated.

42. The image projection apparatus according to claim 25, wherein:
a gray scale of a pixel displayed by at least one of the mirror elements is between 9 bit and 16 bit.

43. The image projection apparatus according to claim 25, wherein:
each of the sub-mirror elements has an ON state in which the illumination light is reflected toward the projection optical, system and an OFF state in which the illumination light is not reflected toward the projection optical system, and
a deflection angel between the ON state and the OFF state is 14° to 28°.

44. A mirror device having a plurality of mirror elements for modulating illumination light from a light source, comprising:
an electrode arranged on a substrate;
a plurality of hinges provided in the substrate;
a mirror element arranged on the hinge; and
a control circuit for controlling the mirror element,
wherein the control circuit of each of the mirror element is connected to at least two word lines or two bit lines.

45. A mirror device having a plurality of mirror elements for modulating illumination light from a light source, comprising:
an electrode arranged on a substrate;
a plurality of hinges provided in the substrate;
a mirror element arranged on the hinge; and
a control circuit for controlling the mirror element,
wherein the control circuit controls the plurality of mirror elements as one group.
